(19) United States
(12) Patent Application Publication
(10) Pub. No.: US 2026/0290348 A1
(43) Pub. Date: Sep. 24, 2026

(54) SYSTEM

(71) Applicant: SoftBank Group Corp., Tokyo (JP)

(72) Inventor: Dai WATANABE, Tokyo (JP)

(73) Assignee: SoftBank Group Corp., Tokyo (JP)

(21) Appl. No.: 19/567,308

(22) Filed: Mar. 16, 2026

(30) Foreign Application Priority Data
Mar. 19, 2025 (JP) 2025-045165

(51) Int. Cl. G10L 15/26; G06N 20/00; H04L 51/02

(52) U.S. Cl. CPC G10L 15/26; G06N 20/00; H04L 51/02

(57) ABSTRACT

A system includes a processor that is configured to input a prompt to a generative artificial intelligence model to instruct the generative artificial intelligence model to generate specific questions according to an industry, an occupation, and a role, convert application history information of an applicant into digital data and extract related information from the digital data by using a natural language processing technique, and input, based on the related information, a prompt to the generative artificial intelligence model to instruct the generative artificial intelligence model to generate appropriate questions, and convert conversation content during an interview into text data by using a speech recognition technique and analyze an emotion and a facial expression by using an emotion analysis engine.

### CROSS-REFERENCE TO RELATED APPLICATION

This application is based on and claims priority under 35 USC 119 from Japanese Patent Application No. 2025-045165 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recruitment and interview processes rely heavily on human interviewers to generate questions, conduct interviews, and evaluate candidates, which causes several problems. First, the quality and content of interview questions vary depending on the individual interviewer, and it is difficult to consistently generate questions that are optimally tailored to a specific industry, occupation, and role. Second, when applicant resume information is handled manually, it is not effectively converted into structured data, and related information such as skills, experience, and suitability for a given position is not fully leveraged in generating questions. Third, analysis of interview conversation content is typically limited to subjective human judgment and is not systematically converted into machine-analysable data, so emotional states and non-verbal cues such as expressions are not consistently reflected in evaluation. In addition, scheduling of interviewers and overall recruitment workflow management are often performed separately and manually, resulting in inefficient use of interviewer resources and limited scalability of hiring operations. Accordingly, there is a need for a system that can automatically generate interview questions appropriate for an industry, occupation, and role based on applicant information, can convert interview conversation content into text and analyze emotion and expression, and can integrate these functions with scheduling and workflow management in order to automate and improve the efficiency of recruitment operations.

### SUMMARY

To solve the above problems, a system according to the present invention comprises a processor configured to cooperate with a plurality of software components including a generative artificial intelligence model, a natural language processing engine, a speech recognition engine, an emotion analysis engine, a scheduling system, and a workflow management system. The processor is configured to input a prompt to the generative artificial intelligence model to instruct the generative artificial intelligence model to generate specific questions according to an industry, an occupation, and a role, such that the content and difficulty of the questions are dynamically tailored to the target position. The processor is further configured to convert application history information of an applicant, such as a resume and a curriculum vitae, into digital data, to extract related information such as skills, experience, and job history from the digital data by using a natural language processing technique, and, based on the related information, to input a prompt to the generative artificial intelligence model to instruct the generative artificial intelligence model to generate appropriate questions that reflect the applicant's background. The processor is also configured to convert conversation content during an interview into text data by using a speech recognition technique and to analyze an emotion and a facial expression of the applicant by using the emotion analysis engine, thereby enabling objective, machine-processable evaluation of the interview. In addition, the processor is configured to use the scheduling system to arrange an interviewer or to release the interviewer from the interview, and to use the workflow management system to realize automation and efficiency improvement of recruitment operations, such that end-to-end hiring workflows from interview preparation through evaluation and decision-making can be streamlined and partially or fully automated.

The term “processor” refers to one or more hardware processing units, such as a central processing unit (CPU), a graphics processing unit (GPU), a digital signal processor (DSP), or any combination thereof, that executes instructions to perform the functions described in the present specification and claims.

The term “generative artificial intelligence model” refers to a machine learning model, including but not limited to a large language model or other neural network-based model, that generates text, questions, or other content in response to an input prompt.

The term “prompt” refers to input data, typically in the form of natural language text or structured text, that is provided to the generative artificial intelligence model to specify conditions, constraints, or instructions for generating output content.
The term “industry” refers to a category of economic activity or business field, such as finance, manufacturing, information technology, healthcare, or retail, to which an applicant's past experience or a target job position belongs.
The term “occupation” refers to a general type of job or profession, such as engineer, salesperson, consultant, manager, or designer, that characterizes the work performed by an individual.
The term “role” refers to a specific function, position, or responsibility within an occupation or within an organization, such as backend engineer, project manager, team leader, or customer support representative.
The term “application history information” refers to information related to an applicant's past education, employment, skills, certifications, and other background details, including resumes, curricula vitae, job histories, and similar documents.
The term “digital data” refers to information represented in a machine-readable form, such as text encoded in a character encoding scheme, structured records in a database, or other electronic data formats that can be processed by the processor.
The term “natural language processing technique” refers to a computational method or algorithm for analyzing, understanding, or extracting information from human language text, including but not limited to tokenization, part-of-speech tagging, named entity recognition, parsing, and semantic analysis.
The term “related information” refers to information extracted from application history information that is relevant to recruitment or interview processes, including skills, work experience, job titles, industries, roles, education, and other attributes of an applicant.
The term “appropriate questions” refers to questions that are generated based on the related information of the applicant and on the target industry, occupation, and role, and that are suitable for evaluating the applicant's suitability for a position.
The term “conversation content” refers to spoken or recorded utterances exchanged during an interview between an applicant and an interviewer or between an applicant and an automated system, including questions, answers, and other verbal interactions.
The term “speech recognition technique” refers to a computational method or system that converts spoken audio signals into corresponding text data by identifying and transcribing words or phrases in the audio.
The term “text data” refers to information represented as a sequence of characters or tokens, typically encoded in a standard character encoding scheme, that corresponds to the content of spoken or written language and is processable by software.
The term “emotion analysis engine” refers to a software component or system that analyzes input data, such as audio signals, text, images, or video frames, to estimate or classify emotional states of an individual, for example, calm, nervous, confident, or stressed.
The term “emotion” refers to an inferred or classified affective state of an applicant during an interview, such as happiness, anxiety, confidence, tension, or other psychological or affective conditions detectable from voice, text, or facial expressions.
The term “facial expression” refers to a configuration or movement of facial features, including eyes, eyebrows, mouth, and other parts of the face, that may indicate an emotional state or reaction of an applicant during an interview.
The term “scheduling system” refers to a software system or module that manages appointment times, interviewer availability, interview slots, and related resources in order to arrange, modify, or cancel interview schedules.
The term “interviewer” refers to a human participant or an automated agent that conducts or supervises an interview, asks questions, or evaluates an applicant, and whose scheduling or allocation may be managed by the scheduling system.
The term “workflow management system” refers to a software system or platform that defines, executes, monitors, and manages a sequence of business processes or tasks related to recruitment operations, including but not limited to application review, interview scheduling, evaluation, approval, and final decision-making.
The term “recruitment operations” refers to activities involved in hiring personnel, including receiving and managing applications, screening candidates, conducting interviews, evaluating candidates, coordinating with stakeholders, and making hiring decisions.
The term “automation” refers to the execution of recruitment-related tasks by the system with reduced or no human intervention, based on predefined rules, models, or workflows, in order to perform steps that would otherwise be carried out manually.
The term “efficiency improvement” refers to enhancement of recruitment operations by reducing time, cost, or manual effort, or by increasing consistency, throughput, or accuracy, through the use of the system described in the present specification.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### FIRST EXEMPLARY EMBODIMENT

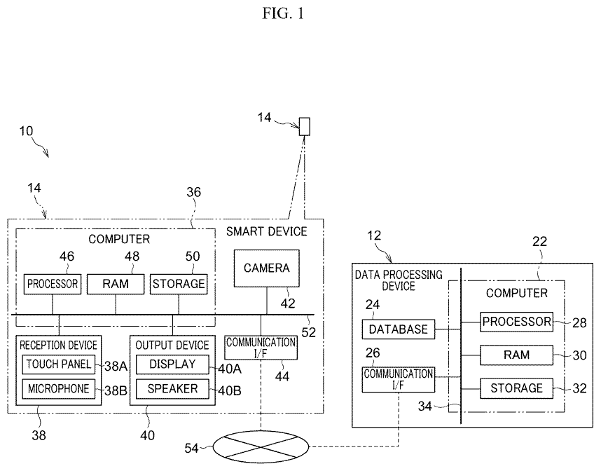

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

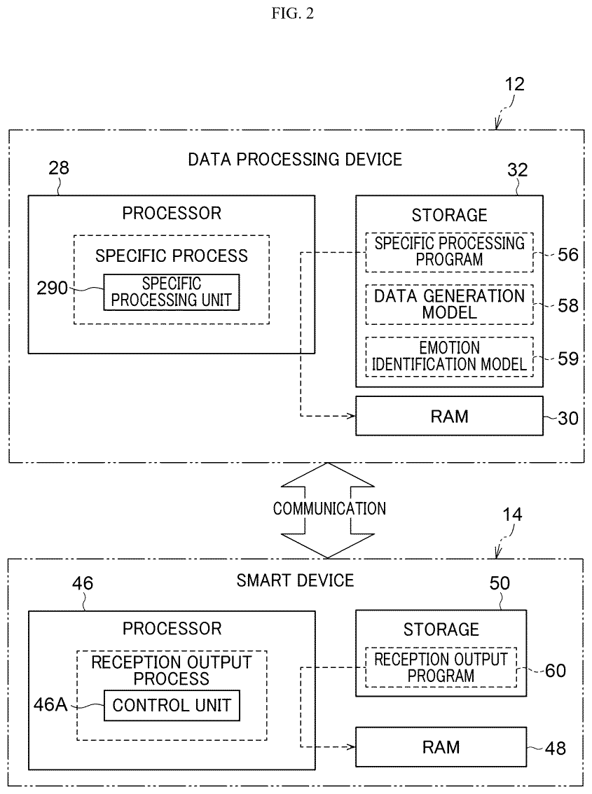

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional interview support systems mainly function as static repositories of generic question sets or as simple scheduling tools. Such systems do not deeply analyze candidate history information nor dynamically tailor interview questions to the specific industry, occupation, role, and skills of a candidate. As a result, these systems fail to provide interviewers with context-sensitive and technically appropriate questions, which leads to inconsistent evaluation quality, subjective assessments, and inefficient interview preparation. Further, even when natural language processing techniques and generative AI models are available, existing systems typically require manual prompt design by human operators. This manual construction of prompt sentences introduces variability, operator bias, and additional workload, and it prevents the full utilization of the capabilities of generative AI models for automatic question generation. In addition, the output of generative AI models is often delivered as unstructured text, requiring further manual editing, de-duplication, and categorization before being usable in a real interview workflow.

Moreover, conventional systems do not integrate multimodal analysis of interview sessions, such as speech recognition of conversation audio and emotion analysis based on textual and expression information, into a unified recruitment workflow. Consequently, evaluation information and process status are not automatically updated in a systematic, machine-usable manner, which limits automation and efficiency gains in the overall recruitment and interview processes.
Accordingly, there is a need for an improved computer-implemented system that: (i) automatically converts candidate history information into structured information by using natural language processing algorithms, (ii) automatically generates optimized prompt sentences for a generative AI model based on such structured information and attribute information including at least industry, occupation, and role, (iii) post-processes and organizes the generated interview question text into a structured, de-duplicated, and categorized form, and (iv) integrates speech recognition and emotion analysis results into workflow management and scheduling in order to automatically update evaluation and progress information. Such a system would improve the functioning of the computer itself by enabling automated, consistent, and efficient generation, organization, and use of interview-related data, rather than merely computerizing a human mental process.

The specific processing by the specific processing unit 290 of the data processing device 12 in Example 1 is realized by the following means.

The present invention provides a server comprising a processor configured to receive, from a terminal, attribute information including at least an industry, an occupation, a role, and history information of a candidate, convert the history information from an electronic file into character information, apply a natural language processing algorithm to the character information to extract information including at least specialized knowledge, experience, skills, and aptitude, and generate structured information based on the extracted information; automatically generate a prompt sentence for input to a generative AI model based on the structured information and the attribute information including at least the industry, the occupation, and the role, embed, in the prompt sentence, at least a part of the industry, the occupation, the role, and the skills included in the structured information as prompt elements, transmit the prompt sentence to the generative AI model, and cause the generative AI model to generate interview question text specialized for the candidate; analyze output from the generative AI model, split the interview question text into individual questions, remove duplicate or similar questions, organize the individual questions by question category, and transmit the organized questions to the terminal; convert conversation audio during an interview into character information by using a speech recognition algorithm, apply an emotion analysis algorithm to at least one of the character information and acquired expression information to analyze an emotional state, and provide an analysis result of the emotional state; and automatically update evaluation information and progress information related to a recruitment operation based on at least one of the interview question text and the analysis result of the emotional state, and supply the evaluation information and the progress information to a workflow management algorithm and a scheduling algorithm so as to automate and improve efficiency of an interview process and a recruitment process. This enables the computer system to automatically transform unstructured candidate and interview data into structured, machine-usable artifacts, to generate and refine interview questions through optimized prompt sentences for a generative AI model, and to integrate multimodal interview analysis into workflow and scheduling control, thereby improving the technical performance, automation level, and consistency of computer-based recruitment support.

The term “processor” refers to a hardware-based or virtual information processing unit, such as a central processing unit or a computing core, that executes instructions to perform data reception, transformation, analysis, and control operations within the system. The term “terminal” refers to an information processing apparatus, such as a client device or user interface device, that communicates with the server to transmit and receive data related to candidate information, interview questions, and evaluation results.

The term “industry” refers to a classification category of economic or production activities used to characterize a business domain associated with a candidate's experience or a target position.
The term “occupation” refers to a classification category of work content or job content used to characterize a type of job associated with a candidate or a target position.
The term “role” refers to a classification category that indicates responsibilities or functions expected of an individual within an organization or project.
The term “history information” refers to digital information representing past experiences and background of a candidate, including at least résumés, career records, and similar biographical data.
The term “electronic file” refers to a machine-readable data object stored in a storage medium, which may include documents, images, or other digital representations of candidate history information.
The term “character information” refers to data represented in the form of text, including letters, numbers, and symbols, that has been converted from electronic files or audio.
The term “natural language processing algorithm” refers to a computational method or procedure that analyzes and processes human language text to extract linguistic or semantic information.
The term “specialized knowledge” refers to domain-specific understanding, technical expertise, or professional know-how identified from the candidate's history information.
The term “experience” refers to information derived from the candidate's past activities, projects, positions, or responsibilities over time.
The term “skills” refers to capabilities or proficiencies, including technical skills, soft skills, and other abilities, extracted from the candidate's history information.
The term “aptitude” refers to an intrinsic or developed suitability of a candidate for performing particular tasks or roles, inferred from the candidate's history information.
The term “structured information” refers to data that has been organized into a predefined format, such as key-value pairs or records, enabling systematic access, analysis, and processing by a computer.
The term “generative AI model” refers to a machine learning model, such as a neural network-based language model, that generates new data or text based on input data and learned parameters.
The term “prompt sentence” refers to a text-based instruction or query supplied to a generative AI model to guide generation of desired output, such as interview questions.
The term “prompt element” refers to a component of a prompt sentence, including at least portions of industry, occupation, role, or skills, that constrains or directs the behavior of a generative AI model.
The term “interview question text” refers to character information representing one or more questions intended to be used in an interview for evaluating a candidate.
The term “question category” refers to a classification label assigned to interview questions, such as technical, behavioral, or cultural categories, based on their content or evaluation purpose.
The term “speech recognition algorithm” refers to a computational method that converts audio signals of spoken language into character information.
The term “expression information” refers to data representing non-verbal cues, such as facial expressions or visual features, acquired from sensors or imaging devices during an interview.
The term “emotion analysis algorithm” refers to a computational method that analyzes character information, expression information, or both, to estimate an emotional state of an interview participant.
The term “emotional state” refers to a condition of affect or sentiment, such as happiness, stress, confidence, or hesitation, inferred by applying an emotion analysis algorithm.
The term “evaluation information” refers to data representing assessment results of a candidate, including scores, ratings, comments, or decision indicators generated or updated by the system.
The term “progress information” refers to data representing a status of a recruitment or interview process, including stages, milestones, and completion states associated with a candidate.
The term “recruitment operation” refers to a sequence of activities performed to select candidates for positions, including at least screening, interviewing, evaluating, and making hiring decisions.
The term “workflow management algorithm” refers to a computational method that controls, sequences, and tracks tasks and states within a business process, such as a recruitment workflow.
The term “scheduling algorithm” refers to a computational method that determines or optimizes time allocation, ordering, or assignment of events or tasks, such as interview appointments.
The term “interview process” refers to a sequence of steps related to preparing, conducting, and recording an interview session for evaluating a candidate.
The term “recruitment process” refers to an end-to-end series of operations, including candidate acquisition, screening, interviewing, evaluating, and final selection, managed by the system.

In one embodiment, a server cooperates with one or more terminals operated by a user to implement the claimed system. The server includes at least one processor, a memory, and a communication interface. The processor executes a plurality of software modules stored in the memory. These software modules may include, for example, a web application module, a document processing module, a natural language processing module, a feature extraction module, a prompt generation module, a generative AI interface module, a question post-processing module, a speech recognition interface module, an emotion analysis module, and a workflow and scheduling control module. The server may be implemented on a general-purpose computing platform such as a rack-mounted computer or a virtual machine in a cloud environment, and may run an operating system such as a general server operating system.

The terminal includes at least a processor, a memory, a display, an input device, and a communication interface. The terminal may be realized by a portable communication device, a desktop computing device, or a similar information processing apparatus. The terminal executes client software such as a web browser or a dedicated application to display user interfaces, to transmit candidate history information and attribute information to the server, and to present generated interview questions and analysis results to the user.
The user operates the terminal to select electronic files containing history information of a candidate, such as files in document formats or portable document formats, and to input attribute information indicating at least an industry, an occupation, and a role relevant to a target position. The terminal transmits the electronic files and the attribute information to the server via a communication network.
The server executes the document processing module to transform the received electronic files into character information. For example, when a portable document format file is received, the server employs a library programmed to parse such files, reads each page, and extracts textual content line by line. When a document file in a word processing format is received, the server employs a document processing library that reads a structured representation of paragraphs and tables, and converts them into continuous character information. The server may normalize character encodings, remove control characters, and standardize whitespace during this conversion. As a result, the server obtains a textual representation of the candidate's résumé and career history that is suitable for further machine processing.
The server executes the natural language processing module to analyze the character information and to generate structured information. In one example, the server employs a natural language processing framework such as a pipeline including tokenization, sentence segmentation, part-of-speech tagging, dependency parsing, and named entity recognition. The server loads a language model pre-trained on a large corpus of textual data. The language model may be based on a transformer architecture including multiple self-attention layers, feed-forward networks, and layer normalization components. The server applies the model to the character information to obtain, for each token and sentence, linguistic annotations such as syntactic roles and semantic entity types.
The server executes the feature extraction module to derive higher-level attributes from the annotated text. The server identifies terms or phrases corresponding to job titles, industries, skills, tools, and technologies by comparing recognized entities to controlled vocabularies or learned embedding spaces. The server computes vector representations of sentences using contextual embeddings and applies a trained classifier model, for example a transformer-based classifier with a softmax output layer, to assign labels such as “specialized knowledge,” “experience,” “skills,” and “aptitude” to sentences or segments. The classifier has been trained using supervised learning, where the server or another computing system previously minimized a cross-entropy loss function between predicted labels and ground-truth labels by updating model weights using an optimization algorithm such as stochastic gradient descent or a variant thereof. Through this training, the classifier acquires decision boundaries in a high-dimensional feature space that differ from simple keyword matching and that enable robust extraction of semantically relevant information.
The server organizes the extracted features into structured information. The server may build data records each having fields for industry, occupation, role, skills, experience summary, and achievements. For example, the server aggregates sentences labeled as “experience” into a condensed experience summary by applying a sentence-ranking method based on cosine similarity between sentence embeddings and an “importance” vector learned during training. The server similarly aggregates skills into a normalized skill list by mapping synonymous terms to canonical entries using a similarity threshold in the embedding space. This structured information is stored in a relational or document-oriented data store in association with an identifier for the candidate.
The server executes the prompt generation module to construct a prompt sentence for a generative AI model. Unlike manual prompt creation by a human operator, the server generates the prompt automatically according to predetermined rules and learned heuristics. The server selects a template according to the industry, occupation, and role fields in the structured information. The server then embeds, into the template, at least a subset of the structured information, including key skills, relevant experience elements, and role descriptions. The server may enforce constraints such as maximum character length, ordering of elements by importance score, and inclusion of both technical and behavioral aspects.
For example, the server may generate a prompt sentence such as:
“Based on the following candidate profile, generate 10 interview questions for a software engineer position in the IT services industry, focusing on the backend engineer role. Skills: Python, Django, REST API, PostgreSQL, AWS, Docker. Experience summary: 5 years of experience developing and maintaining web applications, designing RESTful APIs, and deploying services on cloud infrastructure. Include both technical and behavioral questions, and focus on evaluating practical problem-solving ability and project experience.”
In another example, the server may generate a prompt sentence such as:
“Using the information extracted from the candidate's résumé, generate 10 interview questions for a software engineer position in the IT services industry. Role: Backend engineer responsible for API design and implementation. Skills: Python, Django, REST API, PostgreSQL, AWS, Docker. Experience summary: 5 years of experience building and maintaining web applications and RESTful APIs deployed on cloud infrastructure. Include both technical and behavioral questions, and focus on evaluating practical problem-solving ability and project experience.”
The server then executes the generative AI interface module to transmit the prompt sentence to a generative AI model. The generative AI model may be a large-scale language model based on a transformer architecture, which includes an embedding layer, multiple stacked self-attention blocks, and an output projection layer. The model has been trained on a large corpus of natural language text using an objective such as next-token prediction or masked-token prediction, with loss functions such as cross-entropy and optimization methods such as Adam. During training, the model learns weight matrices governing attention scores and feed-forward transformations. The trained parameters are stored in a model file and loaded at inference time.
The server supplies the prompt sentence as part of an input sequence to the generative AI model and specifies inference parameters such as maximum output length, sampling temperature, and top-k or top-p constraints. The generative AI model responds with generated character information representing interview question text. Because the prompt sentence includes structured and prioritized elements automatically derived by the server, the generated questions tend to be more specific and consistent with the candidate's profile than questions produced by a manually crafted, generic prompt. This automatic and optimized prompt generation represents a non-conventional use of computer resources: the server restructures and compresses high-dimensional candidate information into a prompt that is tailored to the internal representation and behavior of the generative AI model, thereby improving the quality and relevance of the generated output and reducing the need for human-curated content.
The server executes the question post-processing module to transform the raw generated character information into a structured set of interview questions. The server first segments the output into individual questions by detecting sentence boundaries, interrogative markers, and numbering patterns. The server then computes similarity scores between questions using vector representations obtained from a sentence embedding model. If the similarity between two questions exceeds a threshold, the server removes one of them as a duplicate or near-duplicate. The server may categorize each question into types such as “technical,” “behavioral,” or “cultural fit” by applying a lightweight classifier trained on labeled question data. The result is stored as a list of question objects with attributes including text, category, and relevance scores. This processing reduces redundancy and improves the organization of the question set, and it is implemented by algorithms that are not readily performed at human speed or scale, thus constituting a technical improvement in how the computing system manages and structures generated data.
The server transmits the organized questions to the terminal. The terminal displays the questions in a user interface, optionally grouped by category. The user reviews the questions and may select a subset for use in an interview. Because the questions are already refined and categorized by the server, the terminal can render the content without complex local processing, reducing client-side computational load and network traffic by avoiding repeated requests for additional question sets.
The server further executes the speech recognition interface module and the emotion analysis module to process data from an actual interview. When the user conducts an interview and records conversation audio through the terminal, the terminal transmits the audio stream to the server or to a connected speech recognition service. The server converts the audio stream into character information using a speech recognition algorithm that models acoustic features and language probabilities, for example using a neural acoustic model and a language model. The server then applies the emotion analysis algorithm to at least one of the recognized text and separately acquired expression information, such as video frames with facial features. The emotion analysis algorithm may combine text-derived sentiment scores and facial action unit activations using a multimodal neural network that outputs probabilities for emotional states such as confidence, stress, or hesitation. This network may be trained using a loss function that measures divergence between predicted emotion distributions and annotated ground-truth labels, with weight updates performed via backpropagation.
The server associates the emotional state analysis results with specific interview questions and time segments of the interview. The server then updates evaluation information and progress information stored in a workflow management data structure. For example, the server may maintain a state machine for each candidate, with states such as “screening,” “first interview,” “second interview,” and “decision,” and may automatically transition states based on completion of interviews and thresholds in evaluation scores. The server supplies this updated information to a workflow management algorithm that determines which tasks are ready for execution and to a scheduling algorithm that identifies future interview slots and assigns them to interviewers. This integrated processing results in an automated and technically optimized control of the recruitment workflow, reducing manual tracking errors and enabling large-scale, concurrent management of many candidates with consistent rules that are difficult to apply manually.
The described system improves computer technology in several ways. First, the automatic transformation of unstructured candidate documents into structured information uses trained models and specialized text-processing pipelines to reduce noise, normalize data, and extract relevant features, thereby improving the accuracy and consistency of downstream computations compared to ad hoc keyword searches or manual reading. Second, the prompt generation module leverages structured information and learned heuristics to construct prompt sentences that are better aligned with the generative AI model's internal representations, resulting in higher-quality question generation, reduced inference time (due to more constrained search space), and lower communication overhead (since fewer iterations of question generation and editing are needed). Third, the question post-processing algorithms, including similarity-based de-duplication and automatic categorization, enhance data management within the server, leading to reduced storage of redundant data, faster retrieval of appropriate questions, and more efficient rendering on the terminal. Fourth, the joint use of speech recognition and emotion analysis in combination with workflow and scheduling control enables the server to automatically and reliably update complex state information, which improves the technical performance of the system's control logic and reduces processing latency in decision-making compared to human-managed workflow systems.
The server employs non-conventional and non-generic combinations of algorithms and data structures. For example, the server uses embeddings and similarity thresholds not merely for information retrieval, but specifically to refine outputs of a generative AI model in the context of interview question generation. The server also uses structured candidate features as prompt elements in a way that is tuned to the generative model's behavior, rather than simply passing raw text to the model. These design choices are based on machine-learned relationships between candidate features and effective question sets, which are not part of routine human decision making. Additionally, the server executes rule-based logic that combines continuous model outputs (probabilities, similarity scores) with discrete workflow states, enabling deterministic transitions and scheduling decisions that are not achievable by mere human intuition at scale.
Various modifications and alternative embodiments are possible within the scope of the claims. For example, the server may employ different natural language processing frameworks, such as a recurrent neural network-based model or a convolutional model, instead of a transformer-based model. The generative AI model may be hosted as a remote service or may reside on the same physical machine as the server. The emotion analysis algorithm may rely solely on text, solely on facial expressions, or on a combination of multiple modalities, and may use different neural architectures or rule-based classifiers. The structured information may be stored in different formats, such as relational tables, key-value stores, or serialized graph structures. The scheduling algorithm may implement different optimization strategies, such as constraint satisfaction, heuristics, or linear programming, to assign interviews. In yet another embodiment, the terminal may perform part of the preprocessing or visualization, while the server focuses on heavy model inference and data management, thereby balancing computational load across devices.
Through these embodiments, the server, the terminal, and the user cooperate to implement a system that uses generative AI models and prompt sentences in a technically specific way, transforming unstructured inputs into structured, machine-usable artifacts and integrating multimodal analysis with workflow control, thereby improving the functioning of the underlying computer systems and achieving technical effects such as improved accuracy, speed, and resource efficiency.

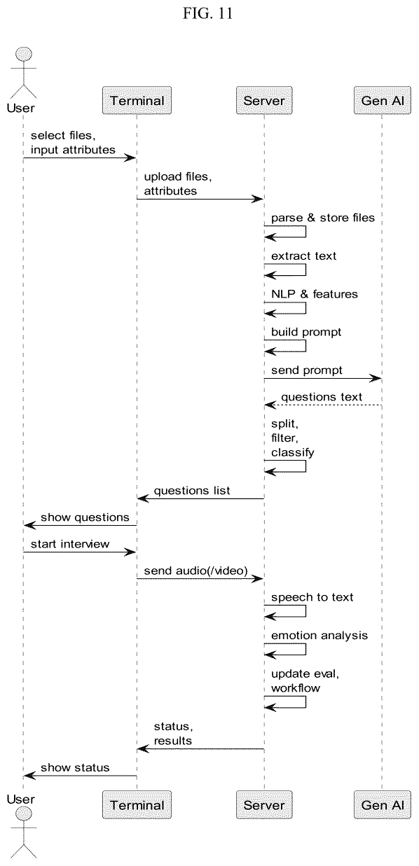

The following describes the processing flow using FIG. 11.

### Step 1:

The user operates the terminal to input candidate attribute information and history information.
The user selects one or more electronic files containing résuméand career records and inputs attribute fields such as industry, occupation, and role into a form on the terminal.
Input: Raw electronic files (for example, document or PDF files) and attribute values (industry, occupation, role) entered via the terminal interface.
Output: A structured request object at the terminal containing file binaries and attribute fields ready to be transmitted to the server.

### Step 2:

The terminal transmits the candidate attribute information and history information to the server.
The terminal packages the selected files and attribute fields into a network request, for example an HTTP POST request with multipart/form-data or a similar protocol, and sends the request through a communication interface.
Input: The request object containing file binaries and attribute fields generated in Step 1.
Output: A data stream delivered to the server, including the raw file content and the associated attribute information.

### Step 3:

The server receives the transmitted data and stores the electronic files.
The server parses the incoming request, extracts the file binaries and attribute fields, assigns a candidate identifier, and writes the files to a storage subsystem such as a file system or object store. The server also registers metadata in a persistent data store.
Input: The data stream from the terminal that includes candidate files and attribute information.
Output: Stored electronic files linked to a candidate identifier and a metadata record in a database indicating file locations and attribute values.

### Step 4:

The server converts the stored electronic files into character information.
The server loads the stored files and determines their formats based on metadata or file signatures. For document formats, the server uses a document processing routine to extract textual content, removes non-textual elements, and normalizes character encodings.
Input: Electronic files and associated metadata retrieved using the candidate identifier.
Output: Clean character information representing the textual content of the candidate's résuméand career history.

### Step 5:

The server applies a natural language processing algorithm to the character information to generate annotated text.
The server passes the character information through a language processing pipeline that performs tokenization, sentence segmentation, part-of-speech tagging, and named entity recognition, and optionally dependency parsing. The server attaches linguistic labels and entity types to text segments.
Input: Clean character information produced in Step 4.
Output: Annotated text data in which each token or sentence is associated with syntactic roles and semantic entity labels.

### Step 6:

The server extracts features related to specialized knowledge, experience, skills, and aptitude to form structured information.
The server executes a feature extraction routine that analyzes the annotated text, identifies occurrences of job titles, skills, tools, industries, and role descriptions, and classifies sentences into categories such as “specialized knowledge,” “experience,” “skills,” and “aptitude” using a trained classifier. The server aggregates these elements into structured fields.
Input: Annotated text data from Step 5.
Output: Structured information including fields such as industry, occupation, role, skills list, experience summary, and achievements associated with the candidate.

### Step 7:

The server refines and normalizes the structured information.
The server maps synonymous or redundant skill terms to canonical entries using similarity calculations in an embedding space, merges overlapping experience descriptions, and generates concise summaries by selecting representative sentences according to importance scores.
Input: Initial structured information generated in Step 6.
Output: Refined structured information with normalized skills, condensed experience summaries, and coherent role descriptions.

### Step 8:

The server generates a prompt sentence for a generative AI model based on the refined structured information and the attribute information.
The server selects a template according to the industry, occupation, and role fields, then embeds specific skills, experience summaries, and role details into the template in a predetermined order. The server constructs a complete textual instruction that will guide the generative AI model.
Input: Refined structured information from Step 7 and original attribute information (industry, occupation, role).
Output: A prompt sentence that encodes candidate-specific attributes and desired question characteristics in natural language.

### Step 9:

The server optionally optimizes the prompt sentence by applying formatting rules and length constraints.
The server checks the length of the prompt sentence, reorders elements to prioritize important skills and experiences, and enforces inclusion of both technical and behavioral evaluation requirements. The server truncates or reformats segments to comply with generative AI model input constraints.
Input: Initial prompt sentence created in Step 8.
Output: An optimized prompt sentence that fits model input limits and preserves essential candidate features and instructions.

### Step 10:

The server transmits the prompt sentence to the generative AI model and requests interview question text.
The server forwards the optimized prompt sentence to a generative AI model endpoint, specifying inference parameters such as maximum output length and sampling configuration.
The server initiates a generation request to obtain output text.
Input: Optimized prompt sentence from Step 9 and configuration parameters for the generative AI model.
Output: Raw generated character information from the generative AI model, typically including multiple candidate interview questions in text form.

### Step 11:

The server parses the raw generated character information into individual interview questions.
The server analyzes the generated text, detects sentence boundaries and list markers, and separates the text into discrete question strings. The server removes non-question text such as introductory phrases if present.
Input: Raw generated character information received in Step 10.
Output: A preliminary list of individual interview question strings.

### Step 12:

The server removes duplicate or similar interview questions.
The server computes similarity scores between all pairs of questions using sentence embeddings or other similarity measures and compares the scores to a threshold. When the similarity exceeds the threshold, the server discards one of the pair as redundant.
Input: Preliminary list of question strings from Step 11.
Output: A deduplicated list of interview questions in which highly similar or identical questions are removed.

### Step 13:

The server categorizes the interview questions by question category.
The server applies a classification routine that assigns each question to one or more categories such as “technical,” “behavioral,” or “cultural fit,” based on features such as keywords, syntactic patterns, and learned classifier outputs.
Input: Deduplicated list of interview questions from Step 12.
Output: A categorized question list where each question is associated with at least one question category label.

### Step 14:

The server generates a structured response containing the categorized questions and related metadata.
The server constructs a data structure that includes the candidate identifier, timestamp, ordered question list, and category information, and prepares this data for transmission to the terminal.
Input: Categorized question list from Step 13 and candidate context data.
Output: A structured question data package ready for delivery to the terminal.

### Step 15:

The server transmits the structured interview questions to the terminal.
The server sends the question data package through the communication interface to the terminal, using a defined communication protocol and encoding.
Input: Structured question data package produced in Step 14.
Output: A received data payload at the terminal containing organized interview questions and associated metadata.

### Step 16:

The terminal presents the generated interview questions to the user.
The terminal decodes the received data payload, renders the question text on the display in a user interface, and optionally groups the questions by category or importance.
Input: Question data payload delivered from the server in Step 15.
Output: A visual presentation of interview questions on the terminal display, available for review and selection by the user.

### Step 17:

The user conducts an interview with the candidate using the presented questions.
The user selects one or more questions from the displayed list, asks them to the candidate in an interview session, and may record notes or evaluations using input components of the terminal.
Input: Displayed questions and any selection operations performed by the user.
Output: Interview interactions, including audio conversation and optionally textual notes or ratings entered via the terminal.

### Step 18:

The terminal transmits conversation audio and optional visual information from the interview to the server.
The terminal captures audio signals from a microphone and, when applicable, image data from a camera, encapsulates these signals into a stream or file format, and sends them to the server using a communication protocol.
Input: Raw audio data and optional image data captured during the interview.
Output: A multimodal data stream delivered to the server for speech recognition and emotion analysis.

### Step 19:

The server converts the conversation audio into character information using a speech recognition algorithm.
The server processes the incoming audio stream, extracts acoustic features such as spectrograms, applies an acoustic model and language model, and decodes the most probable word sequence. The server outputs textual transcriptions of the interview conversation.
Input: Audio data stream received from the terminal in Step 18.
Output: Character information representing transcribed interview dialogue.

### Step 20:

The server analyzes emotion based on at least one of the transcribed text and the acquired expression information.
The server feeds the transcribed text and, when available, facial or expression features into an emotion analysis model that computes scores for emotional states such as confidence, stress, or hesitation. The server may combine text-based sentiment indicators with visual cues to produce a final emotional state estimate.
Input: Transcribed character information from Step 19 and optional expression information from Step 18.
Output: Emotion analysis results indicating estimated emotional states and associated confidence scores for segments of the interview.

### Step 21:

The server updates evaluation information and progress information related to the candidate's recruitment.
The server integrates the emotion analysis results and, optionally, user-entered scores or notes, into structured evaluation records. The server adjusts progress indicators such as interview stage status based on predefined rules and thresholds applied to the collected data.
Input: Emotion analysis results from Step 20 and any evaluation data supplied by the user through the terminal.
Output: Updated evaluation records and progress state entries stored in the server's workflow management data structures.

### Step 22:

The server supplies updated evaluation and progress information to workflow management and scheduling functions.
The server passes the latest evaluation and progress data to algorithms that determine subsequent actions, such as scheduling another interview, generating follow-up tasks, or marking the recruitment stage as complete. The algorithms may compute optimal time slots and resource allocations based on constraints and availability.
Input: Updated evaluation and progress information from Step 21.
Output: Workflow control decisions and scheduling outcomes that can be used for further automated actions or notifications, and that can be reported back to the terminal as status updates.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional interview support systems primarily provide static question templates or manually maintained question libraries. Such systems require human operators to predefine questions for each business field, job category, and job level, and to manually update those questions in response to changes in required skills or roles. As a result, the system fails to flexibly adapt to diverse applicant profiles, and the processor largely acts only as a retrieval engine for predefined content, rather than as an intelligent question generation engine. This leads to increased configuration effort, limited coverage of specialized domains, and inconsistent evaluation quality among interviews.

Moreover, conventional systems typically do not tightly integrate automated extraction of applicant attributes from unstructured documents and interview conversation streams into the question generation pipeline. Resume information is often processed manually or via simple keyword search, which cannot reliably derive structured candidate attributes such as industry, job type, job level, and detailed skill sets. Likewise, conversational data during the interview, including speech content and emotional state, is rarely captured and fed back into the computation. As a result, the processor is not effectively utilized to transform raw multimodal data (document images, text, audio) into structured control signals for dynamic question generation.
Further, existing systems generally treat generative models, if used at all, as isolated components driven by ad hoc prompts crafted by human users. There is no systematic mechanism in the processor to automatically generate and regenerate prompt sentences based on structured candidate attributes and interviewer inputs, nor to manage real-time interaction with a generative AI model in a way that is tightly coupled with portable terminal display and user feedback. Consequently, generative AI capabilities are underutilized, and the burden of designing and refining prompts falls on the interviewer, which increases cognitive load and reduces system reliability and reproducibility.
Additionally, conventional interview systems do not provide an integrated framework in which a processor coordinates: (i) image-based acquisition of resume data, (ii) natural language processing-based extraction of candidate attributes, (iii) dynamic formation of prompt sentences, (iv) generation of tailored question sets by a generative AI model, (v) real-time distribution of the generated questions to a head-mounted display device, and (vi) collection of interviewer inputs and emotional analysis results to drive iterative refinement of the question set. The absence of such an integrated pipeline means that the computer system cannot autonomously adapt the interview flow in real time, and the processing resources of both the server and the portable device are not optimized for interactive interview guidance. In summary, there is a need for a computer-implemented system in which the processor itself is technically improved by being configured to (1) convert unstructured resume and conversational data into structured candidate attribute information, (2) automatically construct and update prompt sentences for a generative AI model, and (3) control real-time delivery and refinement of interview questions on a portable terminal. Such a system should reduce manual intervention, improve consistency and depth of evaluation, and utilize computing resources to automatically orchestrate data acquisition, analysis, and question generation in a closed feedback loop.

The specific processing by the specific processing unit 290 of the data processing device 12 in Application Example 1 is realized by the following means.

The present invention provides a server comprising a processor configured to convert applicant history information, including image-based resume data, into electronic information by using image reading processing, to execute a natural language processing function on the electronic information to extract work experience information and skill information, and to store the extracted information as structured candidate attribute information; to automatically generate a prompt sentence on the basis of the candidate attribute information, the prompt sentence instructing a generative AI model to generate a set of interview questions corresponding to at least a business field, a job category, and a job level; to input the prompt sentence into the generative AI model and acquire a generated question set; to transmit the generated question set, via a communication network, to a portable information terminal device, and to control real-time display of the question set on the portable information terminal device during an interview; to acquire conversational audio during the interview, to convert the conversational audio into character information by using a speech recognition function, and to analyze an emotional state from at least one of the conversational audio and the character information by using an emotion analysis function; and to receive an operation input or a voice input from an interviewer indicating at least one condition related to question difficulty, question type, or number of questions, to regenerate the prompt sentence on the basis of the condition and the candidate attribute information, and to re-input the regenerated prompt sentence into the generative AI model so as to cause generation of an additional question or a modified question. This enables a technically improved computer system in which the processor orchestrates an end-to-end pipeline that transforms unstructured applicant and interview data into structured control information for a generative AI model, dynamically constructs and refines prompt sentences, and provides adaptive, real-time interview guidance via a portable terminal, thereby reducing manual configuration, enhancing consistency and depth of evaluation, and improving utilization of computational resources in the interview support process.

The term “processor” refers to a hardware-based data processing unit, such as a central processing unit or computation core, configured to execute instructions to perform the functions described in the present specification and claims.

The term “generative AI model” refers to an information processing model implemented by software and hardware that, in response to an input prompt sentence, generates new data, such as natural-language text representing interview questions, based on parameters learned from training data.
The term “prompt sentence” refers to a sequence of machine-readable natural-language tokens provided as input to a generative AI model to instruct the generative AI model to generate an output that satisfies specified conditions.
The term “business field” refers to a classification of industrial or commercial activity, used to characterize an organizational domain such as finance, manufacturing, or information services, and to condition generation of interview questions.
The term “job category” refers to a classification of work function, used to characterize the type of occupation or role, such as engineering, sales, or management, and to condition generation of interview questions.
The term “job level” refers to a classification of responsibility or seniority of a position within an organization, such as entry-level, intermediate, or senior, and is used to control complexity and scope of generated interview questions.
The term “applicant history information” refers to information describing a candidate's background, including at least employment history, educational history, and skill records, obtained from documents such as resumes and work history statements.
The term “image reading processing” refers to a series of operations that convert image data containing visual representations of characters into electronic character information that can be processed by a computer, and includes operations such as optical character recognition and image preprocessing.
The term “electronic information” refers to data represented in a machine-readable form suitable for processing by a computer system, including at least character strings, structured records, and encoded multimedia data.
The term “natural language processing function” refers to a software-implemented processing pipeline configured to analyze human language text, including at least tokenization, syntactic or semantic analysis, and extraction of entities or phrases representing work experience and skills.
The term “work experience information” refers to information extracted from applicant history information that describes positions held, duties performed, durations of employment, and associated organizations.
The term “skill information” refers to information extracted from applicant history information that describes abilities or competencies related to tools, technologies, domains, or methodologies possessed by an applicant.
The term “candidate attribute information” refers to a structured representation of attributes of an applicant, including at least business field information, job category information, job level information, work experience information, and skill information.
The term “structured” refers to a data format in which information is arranged according to predefined fields, relationships, or schemas, enabling deterministic access, retrieval, and processing by a computer program.
The term “question set” refers to a collection of two or more questions, typically expressed as natural-language sentences, that are generated for use in an interview and associated with candidate attribute information.
The term “portable information terminal device” refers to a transportable electronic device having at least a display unit, a communication interface, and a control unit capable of executing an application to display interview questions, such as a handheld device or a wearable device.
The term “communication network” refers to a wired or wireless infrastructure used to transmit data between the server and the portable information terminal device, and includes at least packet-switched networks such as local area networks or wide area networks.
The term “head-mounted display device” refers to a wearable type of portable information terminal device configured to be worn on a user's head and including at least one display unit arranged to present visual information within the user's field of view.
The term “real-time display” refers to presentation of information on a display device with a delay sufficiently short that an interviewer can use the information during an ongoing interview session without noticeable latency.
The term “conversational audio” refers to audio signals representing spoken dialogue between an interviewer and an applicant during an interview session.
The term “speech recognition function” refers to a software-implemented processing function that converts audio signals of human speech into character information representing the recognized content of the speech.
The term “emotion analysis function” refers to a software-implemented analysis engine configured to estimate emotional states or affective tendencies based on at least one of audio characteristics, prosodic features, linguistic features, or textual content.
The term “operation input” refers to an instruction signal generated in response to a physical action by an interviewer, including at least pressing of a button, operation of a touch sensor, or manipulation of a user interface control.
The term “voice input” refers to an instruction signal derived from speech uttered by an interviewer and interpreted by a speech recognition function as a command or parameter for the system.
The term “condition related to question difficulty” refers to a parameter specifying a desired complexity level, depth of knowledge, or cognitive load of generated questions.
The term “condition related to question type” refers to a parameter specifying a desired category of questions, including at least technical questions, behavioral questions, or situational questions.
The term “condition related to number of questions” refers to a parameter specifying a target count or range of questions to be generated or selected for an interview.
The term “additional question” refers to a question generated by the generative AI model in response to a regenerated prompt sentence, which is added to an existing question set.
The term “modified question” refers to a question generated by the generative AI model in response to a regenerated prompt sentence, which replaces or revises at least part of an existing question set.
The term “information processing apparatus” refers to an electronic computing device including at least one processor, a memory, and a communication interface, configured to execute software for managing schedules, workflows, or related tasks.
The term “schedule management function” refers to a software function that manages time-based entries, including at least reservation, modification, and cancellation of interview appointments.
The term “workflow management function” refers to a software function that defines, executes, and monitors a set of tasks or procedures related to recruitment operations, including approvals, notifications, and status tracking.
The term “recruitment operation” refers to a set of processes related to hiring personnel, including at least candidate screening, interview scheduling, interview execution, and decision recording.

In one embodiment, a server provides an interview support system in which a processor, a memory, a storage device, and a communication interface are interconnected via an internal bus. The server executes an operating system such as a general-purpose server operating system, and executes application software implementing optical character recognition, natural language processing, generative AI model access, speech recognition, and emotion analysis. The server communicates with at least one terminal via a wired or wireless communication network. The terminal includes, for example, a head-mounted display, a handheld device, or another portable information processing device having a display, an input interface, a wireless communication module, and a local processor. A user, such as an interviewer, operates the terminal during an interview session with an applicant. The server stores applicant history information in a structured data repository. The server receives the applicant history information as digital files including, for example, scanned images of resumes in formats such as JPEG or PNG, and document files in a portable document format. The server uses a software library for image processing, such as a computer vision library, to convert the scanned images into normalized grayscale images and to apply binarization and noise reduction. The server then applies an optical character recognition engine, such as an OCR engine executable on a central processing unit, to convert the image pixels into character codes. The server writes the recognized text data into a persistent storage as unified text records associated with an applicant identifier.

The server executes a natural language processing library, such as a library implementing tokenization, part-of-speech tagging, and named entity recognition. The server loads a language model including word embeddings and syntactic parsing rules into the memory. The server segments the recognized text into sentences and tokens, and applies named entity recognition to detect company names, job titles, time expressions, and skill terms. The server uses rule-based pattern matchers implemented as finite-state machines to detect specific skill expressions, such as “Python programming,” “REST API development,” and “database optimization.” The server maps the detected terms to higher-level categories, such as business field, job category, and job level, by reference to a classification table stored in the storage device.
The server constructs candidate attribute information as a structured data object, for example a record containing fields for business field information, job category information, job level information, work experience information, and skill information. The server stores the candidate attribute information in a relational database or a key-value store with indexed access. Because the server uses a normalized schema for the candidate attribute information, subsequent retrieval operations and join operations are simplified, and query latency is reduced compared to unstructured text search.
The server generates a prompt sentence for a generative AI model by combining the candidate attribute information with template data stored in the memory. The server maintains a plurality of prompt templates, each associated with conditions such as question purpose (technical, behavioral), difficulty level, and interview phase. Each prompt template includes placeholders for business field, job category, job level, and skill list. The server selects a template based on the candidate attribute information and the current interview context, and replaces the placeholders with specific attribute values.
For example, when the candidate attribute information includes a finance business field, a backend engineer job category, a senior job level, and Python programming and REST API development as skills, the server generates a prompt sentence such as:
“You are an interviewer hiring a senior backend engineer in the finance industry. The candidate has 5 years of experience with Python programming, REST API design, and database optimization. Generate 10 interview questions that evaluate advanced Python skills, backend architecture knowledge, and problem-solving ability. Make the questions technically challenging and require detailed explanations.”
In another example, when the user requests beginner-level questions, the server generates a prompt sentence such as:
“Based on the candidate's Python programming skill and junior level experience, generate 5 beginner-friendly interview questions focusing on Python fundamentals, including data types, control structures, and basic functions. Use simple, clear language.”
The server transmits the prompt sentence to a generative AI model implemented as a neural network-based language model. In one embodiment, the generative AI model is a transformer-type neural network deployed on a remote inference platform that the server accesses via an application programming interface over the communication network. The generative AI model includes an encoder-decoder architecture or a decoder-only architecture with multi-head self-attention layers, feed-forward layers, and positional encoding. The model parameters, including weight matrices for attention and feed-forward layers, are stored on a model server and are loaded into accelerator hardware such as graphics processing units or tensor processing units at inference time.
The server sends the prompt sentence as a sequence of token identifiers to the generative AI model. The generative AI model computes, for each token position, a probability distribution over a vocabulary by applying the transformer architecture. The model uses a softmax function on the output logits to produce the probability distribution and selects the next token according to a sampling strategy such as top-k sampling or nucleus sampling. The model repeats this process until a termination condition such as an end-of-sequence token is generated. The model returns the generated token sequence to the server as generated text. The server decodes the token sequence into a question set composed of multiple questions. The server segments the generated text using delimiters such as line breaks, numerical identifiers, or bullet symbols. The server performs a post-processing step in which low-quality or duplicate questions are filtered. In one embodiment, the server computes vector embeddings of each question using a sentence embedding model, and compares cosine similarities between questions. When similarity exceeds a threshold, the server removes redundant questions. The server may further classify questions into categories such as technical, behavioral, or situational by applying a lightweight classifier that evaluates keyword presence or embedding similarity to reference vectors. This structured classification enables the server to present grouped questions to the terminal and to quickly update only a subset when the user requests refinement.
The terminal receives the question set via a communication interface such as a wireless local area network module or a cellular communication modem. The terminal runs an interview display application that parses the question set and stores it in local memory. The terminal displays the questions on a display unit. When the terminal is a head-mounted display, the terminal renders each question in a region of the user's field of view, with navigation indicators for moving forward and backward through the list. The terminal adjusts font size, line wrapping, and brightness according to device configuration data, thereby improving readability and reducing visual strain.
The user wears the head-mounted display or holds the portable terminal and reads the questions during an interview. The user interacts with the terminal using input devices such as touchpads, buttons, or gesture sensors. The terminal detects these operation inputs and sends control messages to the server. The server updates the interview state, for example which question is currently active, which questions have been skipped, and which questions have been marked as important. This state information is stored in the server's memory to support later analysis and audit.
The server acquires conversational audio between the user and the applicant by receiving audio streams from microphones in the terminal. The server applies a speech recognition engine, such as a recurrent neural network or transformer-based acoustic model combined with a language model, to convert the audio signal into character information. The server uses features such as Mel-frequency cepstral coefficients and spectrogram representations as input to the acoustic model, and decodes the most likely word sequence via beam search. The server then analyzes emotional state by applying an emotion analysis module. This module may use a neural network classifier trained on acoustic features, such as pitch, energy, and speaking rate, as well as textual features derived from the recognized words, such as sentiment scores or specific lexical markers. The emotion analysis module outputs probabilities for several emotional categories, such as confidence, nervousness, or hesitation. The server uses the emotional analysis results to adjust subsequent prompt sentences. For example, when the emotion analysis indicates that the applicant is overly nervous and question answers degrade, the server reduces question difficulty by generating a new prompt sentence:
“Generate 5 easier follow-up questions about Python basics that help the candidate explain fundamental concepts in a comfortable manner. Avoid highly abstract or advanced topics.”By systematically integrating emotional state and conversational content into the prompt generation process, the server achieves a feedback loop that is not attainable with manual prompt design. The server thereby modifies the input to the generative AI model based on machine-derived signals, improving the alignment of generated questions with the real-time state of the interview.
The server further receives conditions from the user regarding question difficulty, question type, and number of questions through operation or voice inputs at the terminal. In the case of voice input, the terminal transmits audio commands to the server, and the server uses the same speech recognition engine to decode the commands. The server parses the decoded text to detect control phrases such as “more technical questions,” “fewer questions,” or “add behavioral questions.” The server maps these commands to parameter settings, such as increasing target difficulty level, changing target question type, or modifying target question count. The server stores these parameters and regenerates the prompt sentence with updated references to desired difficulty and type, and with a requested number of questions. Because the server uses structured candidate attribute information and parameterized templates, the regeneration process is performed automatically without manual rewriting of the entire prompt.
In order to improve processing speed and reduce communication load, the server caches intermediate results. For example, the server stores tokenized representations of candidate attribute information and pre-computed embeddings for frequently used skill phrases. When the server generates new prompt sentences for the same candidate, the server reuses these embeddings and templates instead of recomputing them, thereby reducing CPU load and memory access. The server also uses batching of generative AI requests when multiple interviews are running concurrently, grouping prompt sentences and sending them together to the generative AI model. The model then processes the batch in a single inference pass, improving utilization of accelerator hardware and reducing total response latency. The generative AI model itself is trained using a training dataset that includes a large corpus of text data, including code examples, technical documentation, and interview question banks. During training, the model minimizes a loss function, such as cross-entropy loss, between predicted token distributions and ground truth tokens. The model parameters are updated using an optimization algorithm such as stochastic gradient descent with adaptive moment estimation. The training process includes techniques such as learning rate scheduling, dropout regularization, and gradient clipping to stabilize convergence. Data augmentation may be applied by rephrasing training sentences, shuffling question order, or adding synthetic noises to broaden the distribution of input patterns. As a result, the generative AI model learns to generate coherent questions conditioned on prompt sentences, and the server can reliably obtain question sets that match the specified constraints. The server configures the generative AI model invocation with parameters such as maximum output length, sampling temperature, and top-k or top-p thresholds. By adjusting these parameters based on candidate attribute information and interview stage, the server controls variability and depth of generated questions. For example, at an early stage of the interview, the server sets a lower temperature to generate predictable and focused questions, while at a later stage, the server sets a slightly higher temperature to encourage more diverse and exploratory questions. This parameter control constitutes a non-conventional usage of the model that is tightly integrated with structured interview context and device control, rather than a simple one-off text generation.
The server cooperates with an information processing apparatus for schedule management and workflow management. The server exchanges structured messages that represent upcoming interviews, interviewer assignments, and completion status. Because the server stores the interview state and generated question sets in structured form, the server is able to link technical interview content with schedule entries without duplicating unstructured data. This improves data management and reduces inconsistencies between interview logs and schedule records.
The system provides several technical effects. By converting all applicant history information and conversational data into structured candidate attribute information and control parameters for the generative AI model, the server reduces reliance on manual configuration and ad hoc decisions, and allows deterministic repetition of similar interview scenarios across different devices and times. By using specific neural architectures and data structures, the server improves processing speed and accuracy of question generation relative to manual selection from static libraries. The integration of caching and batched inference reduces communication overhead and improves throughput. The use of a head-mounted display as the terminal allows the server to control precise timing and format of question presentation, reducing context-switching overhead for the user and enabling hands-free operation. Because the server continuously updates prompt sentences based on real-time emotional analysis and interviewer commands, the system achieves a closed feedback loop that optimizes computational resources toward generating only those questions that are most relevant at a given time, thereby reducing unnecessary computation and network traffic.
In another embodiment, the terminal is a handheld device such as a tablet. The server changes the presentation format for the question set, such as displaying multiple questions at once and allowing the user to tap to expand detailed follow-up prompts. The underlying data structures and server-side processing remain the same, so that the same candidate attribute information and prompt generation algorithms are reused. In yet another embodiment, the server uses a different natural language processing library or a different speech recognition model, such as a convolutional neural network-based acoustic model, but the same high-level architecture—structured extraction of attributes, template-based prompt generation, transformer-based question generation, and real-time terminal control—is preserved.
Because the server implements these non-conventional combinations of modules, data structures, and control flows, the system does more than simply automate human mental steps. The server modifies the way in which computing resources are allocated for text recognition, language understanding, question generation, and device display. The server thereby improves computer technology itself by structuring previously unstructured applicant data, by enabling adaptive and efficient use of a generative AI model through dynamic prompt sentence management, and by coordinating low-latency interaction between a central server and a portable terminal in a manner that reduces computational redundancy and communication overhead while improving accuracy and consistency of interview guidance.

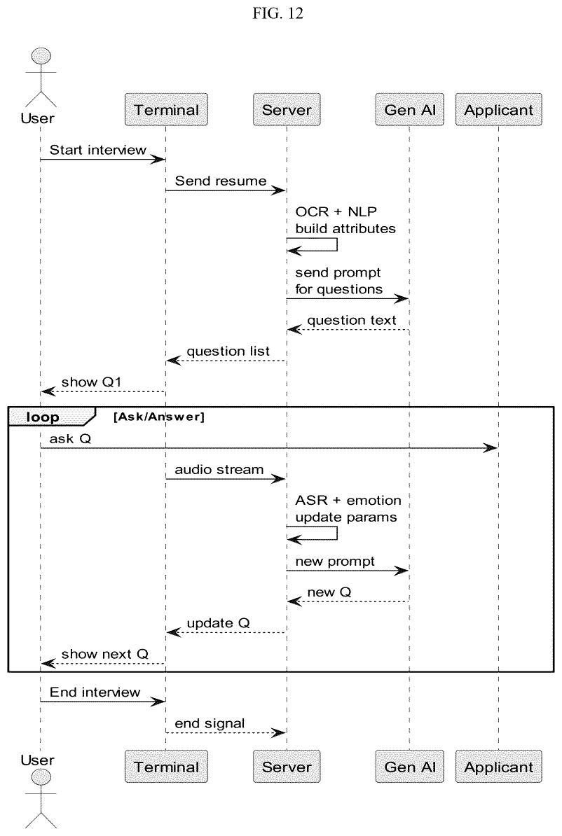

The following describes the processing flow using FIG. 12.

### Step 1:

The server receives applicant history information as input. The input includes at least scanned resume images and electronic document files associated with an applicant identifier. The server stores the raw files in a storage device and normalizes the file formats. The server applies image preprocessing operations, such as grayscale conversion, binarization, and noise reduction, to the scanned images. The server then executes an OCR engine on the preprocessed images to convert pixel patterns into character codes. Based on the recognized characters, the server assembles lines and paragraphs of text. The server outputs electronic text data representing the full resume content, linked to the applicant identifier.

### Step 2:

The server receives the electronic text data from Step 1 as input. The server loads a natural language processing model into memory and applies tokenization, sentence segmentation, and part-of-speech tagging to the text. The server executes named entity recognition and rule-based matching to detect job titles, organization names, dates, and technical skills. The server maps the detected elements to higher-level categories, such as business field, job category, job level, and skill list, using a stored classification table. The server constructs a structured record that includes fields for work experience, education, and skills. The server outputs candidate attribute information as a structured data object associated with the applicant identifier.

### Step 3:

The server receives the candidate attribute information from Step 2 as input. The server retrieves a prompt template corresponding to at least one of the business field, job category, job level, and interview phase. The server fills placeholders in the template with values from the candidate attribute information, and additionally encodes desired parameters such as number of questions and difficulty level. The server concatenates these elements into a coherent prompt sentence in natural language. For example, the server may generate the prompt sentence, “You are an interviewer hiring a senior backend engineer in the finance industry. The candidate has 5 years of experience with Python programming, REST API design, and database optimization. Generate 10 interview questions that evaluate advanced Python skills, backend architecture knowledge, and problem-solving ability. Make the questions technically challenging and require detailed explanations.” The server outputs the finalized prompt sentence as a text string together with associated generation parameters.

### Step 4:

The server receives the prompt sentence and generation parameters from Step 3 as input. The server encodes the prompt sentence into tokens according to a vocabulary used by a generative AI model. The server transmits the token sequence and parameters to the generative AI model via an application programming interface over a communication network. The generative AI model performs neural network inference and returns a generated token sequence as a response. The server decodes the token sequence into human-readable text and segments the text into individual questions by detecting line breaks, numbering, or bullet characters. The server may calculate vector embeddings for each question and compute similarity scores to detect duplicate or overly similar questions, removing redundant entries. The server outputs a question set as a structured list of question texts linked to the candidate and the current interview session.

### Step 5:

The server receives the question set from Step 4 as input. The server formats the question set into a data structure suitable for transmission, for example a list of strings with identifiers and optional category labels. The server sends this formatted question set to the terminal via a communication network using a protocol such as HTTPS or WebSocket. The terminal receives the question set as input. The terminal parses the received data, stores the questions in local memory, and prepares display layouts according to the screen size and resolution. The terminal outputs visual representations of one or more questions on its display, such that the user can read the questions in real time during the interview.

### Step 6:

The user receives the displayed questions from the terminal as visual input. The user uses the questions as a guide and verbally poses them to the applicant. The user interacts with the terminal via an input interface, such as a touchpad, button, or gesture sensor. The user performs actions including moving to the next question, returning to a previous question, or marking a question as important. The terminal receives these operation inputs, updates an internal index of the current question, and requests from the server, if necessary, additional or alternative questions. The terminal outputs updated question displays that reflect the user's navigation and selections.

### Step 7:

The terminal receives audio signals of the ongoing conversation as input through one or more microphones. The terminal may perform initial encoding or compression and transmits the audio stream to the server. The server receives the conversational audio as input and applies a speech recognition engine to convert the audio into text. The server extracts features such as spectral coefficients and prosodic patterns, passes them through an acoustic model, and decodes the most probable word sequence. The server then applies an emotion analysis module to the recognized text and audio features, computing emotion scores such as confidence, anxiety, or hesitation. The server outputs recognized conversational text and associated emotional state indicators for the interview session.

### Step 8:

The server receives the conversational text and emotional state indicators from Step 7 as input, together with the candidate attribute information and the current question set. The server evaluates whether the emotional state and answer content suggest that the current question difficulty or type should be adjusted. For example, the server may detect increased nervousness when technical questions become too complex. The server derives updated control parameters for question difficulty, type, and number, and incorporates these parameters into a new prompt sentence. For instance, the server may generate the prompt sentence, “Based on the candidate's Python programming skill and junior level experience, generate 5 beginner-friendly interview questions focusing on Python fundamentals, including data types, control structures, and basic functions. Use simple, clear language.” The server outputs the new prompt sentence and the updated control parameters.

### Step 9:

The server receives the new prompt sentence from Step 8 as input. The server encodes the prompt sentence into tokens and again sends the tokens and parameters to the generative AI model via the application programming interface. The generative AI model returns a new generated token sequence. The server decodes the token sequence to produce additional or modified questions, segments the text into individual questions, and optionally filters for redundancy and quality. The server produces an incremental question set, including either entirely new questions or revised versions of previous questions. The server outputs this incremental question set for delivery to the terminal.

### Step 10:

The server receives the incremental question set from Step 9 as input and transmits it to the terminal over the communication network. The terminal receives the incremental question set and merges it with the existing question set in local memory, for example by appending new questions to a queue or replacing questions labeled as outdated. The terminal updates its display to indicate that new questions are available and presents the new questions according to the user's navigation commands. The terminal outputs the updated question list on the display in real time. The user then reads and uses the updated questions, completing a feedback loop in which the server and generative AI model adapt the interview content based on candidate responses and user inputs.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented interview systems primarily digitize existing manual workflows without substantially improving the underlying information processing. Typical systems merely present pre-authored questions, record responses, and store results, while leaving question design, candidate adaptation, and evaluation largely manual. As a result, the quality of interview data and the efficiency of processing such data remain limited by static content, unstructured logs, and ad hoc human judgment.

In particular, conventional systems do not leverage generative AI models in a structured manner to dynamically construct prompt sentences from machine-readable condition information, such as business-domain information, job information, and applicant-specific history information. Instead, when generative models are used at all, they are invoked in a non-systematic way, for example by manually entering prompts, which leads to inconsistent question sets, difficulty in reproducing results, and limited integration with downstream analysis modules. This weak coupling between configuration data, prompt generation, and model invocation prevents the computing infrastructure from automatically producing interview content that is tailored to both the job requirements and the applicant's profile. Further, in many existing systems, multimodal response data such as text, audio, and video are handled in a fragmented manner. Audio data, when stored, are often retained as raw media without integrated speech recognition and downstream natural language processing. Video data are typically archived without structured extraction of facial expression and emotion features. Consequently, the processor cannot construct well-structured analysis information combining emotion signals, keyword signals, and temporal context per question and per applicant. This leads to inefficient processing, high resource consumption during manual review, and limited ability to compute objective indices that can be consumed by automated decision support tools.
Additionally, existing systems often lack a coherent mechanism for aggregating analysis results into visualization-ready structures. While dashboards may exist, they are usually thin presentation layers built on top of unoptimized queries, resulting in redundant computation, latency in rendering complex views, and inconsistent metrics across different screens. There is no integrated computing mechanism that defines and executes a stable business-process flow—from interview configuration, prompt construction, generative question generation, multimodal collection, analysis, aggregation, to dashboard delivery—in a way that systematically improves the performance, scalability, and reliability of the overall computing system.
In sum, there is a need for an improved computer system that (i) programmatically constructs prompt sentences for generative AI models from structured condition information and applicant history, (ii) uniformly processes multimodal response data using speech recognition, natural language processing, and image analysis to derive structured analysis information, and (iii) aggregates and converts such analysis information into visualization data suitable for efficient dashboard rendering. Such a system should reorganize the data paths and processing steps at the processor level, thereby improving the functioning of the computer itself in terms of automated configuration, data transformation, storage structure, and interactive retrieval for evaluation.
The specific processing by the specific processing unit 290 of the data processing device 12 in Example 2 is realized by the following means.

The present invention provides a server comprising a processor configured to acquire condition information indicating an interview format and a target work role based on business-domain information and job information, dynamically construct a prompt sentence for causing a generative AI model to generate interview questions based on the condition information, and input the prompt sentence into the generative AI model so as to cause the generative AI model to generate a plurality of interview questions; convert the plurality of interview questions obtained from the generative AI model into at least one output format selected from a text format, an audio format, and a video format, transmit data in the at least one output format to a terminal via a communication path, and cause the terminal to present the plurality of interview questions to an applicant; receive response data of the applicant from the terminal as at least one of text data, audio data, and video data, execute speech recognition processing on the audio data to convert the audio data into text data, perform natural language processing on the text data to extract analysis information including emotion information and keyword information, and perform image analysis on the video data to extract expression information and emotion information; aggregate, based on the analysis information, an emotion index and a keyword index for each question and for each applicant, convert aggregation results into visualization data, construct dashboard data adapted to a display interface based on the visualization data, and transmit the dashboard data to the terminal so as to present the aggregation results to an evaluator; and convert history information of the applicant into digital data, extract related information from the history information by using natural language processing, and input, into the generative AI model, an additional prompt sentence obtained by incorporating the related information into the prompt sentence so as to cause the generative AI model to generate questions according to individual characteristics of the applicant. This enables an improvement in computer functionality by tightly integrating structured condition acquisition, programmatic prompt construction for a generative AI model, multimodal response normalization, and indexed aggregation into visualization-ready dashboard data, thereby reducing manual configuration, enhancing the efficiency and consistency of data processing, and providing an optimized machine-executable workflow for automated interview generation, analysis, and evaluation.

The term “processor” refers to a hardware logic device or a combination of hardware and firmware, such as a central processing unit or an execution core, that executes machine-readable instructions to perform data processing operations described in the present specification.

The term “system” refers to a combination of one or more hardware devices, software components, and communication interfaces, including at least a processor and a terminal, that cooperate to execute the interview automation functions described in the present specification.
The term “condition information” refers to machine-readable data indicating at least an interview format and a target work role, and optionally including business-domain information, job information, and other configuration parameters used to control generation of interview questions.
The term “interview format” refers to a type of media and interaction mode used in an interview session, including at least a text-based format, an audio-based format, and a video-based format for presenting questions and acquiring responses.
The term “target work role” refers to an abstract representation of a professional responsibility or position category, specified in a manner suitable for processing by the system, and used to influence the generation and selection of interview questions.
The term “business-domain information” refers to classification information regarding an industrial sector, functional area, or category of business activity, represented in a structured form and used as part of condition information for configuring an interview.
The term “job information” refers to structured data describing a job or position, including attributes such as functional category, seniority level, or required competencies, used by the processor to control question generation.
The term “prompt sentence” refers to a natural-language or semi-natural-language string constructed by the processor and input to a generative AI model, the string being designed to instruct the generative AI model to generate interview questions or other textual content.
The term “generative AI model” refers to a machine-learned inference model, such as a large language model, that receives a prompt sentence as input and outputs generated data, including text data representing interview questions.
The term “interview questions” refers to machine-readable text items, generated or selected by the system, that are intended to be presented to an applicant in order to elicit responses for evaluation.
The term “output format” refers to a type of media representation of interview questions, including at least a text format, an audio format, and a video format, each of which is suitable for transmission to and presentation by a terminal.
The term “text format” refers to a representation of content as encoded character data, such as a sequence of symbols in a character encoding scheme, that can be displayed by a text-capable user interface.
The term “audio format” refers to a representation of content as digital audio data, such as a waveform or compressed audio stream, that can be played back by sound output hardware.
The term “video format” refers to a representation of content as digital video data, optionally including synchronized audio and image frames, that can be rendered by a display device.
The term “terminal” refers to a user-operated computing device, such as a client device with a display, input interface, and communication function, that exchanges data with the processor and presents questions or dashboard information to a human user.
The term “communication path” refers to a logical or physical connection, such as a wired or wireless network link, through which data are transmitted between the processor and one or more terminals.
The term “applicant” refers to a human subject of an interview session, whose responses to interview questions are acquired and processed by the system.
The term “response data” refers to machine-readable data representing an applicant's answer to one or more interview questions, including at least one of text data, audio data, and video data.
The term “text data” refers to applicant response content represented as encoded character sequences suitable for processing by natural language processing techniques.
The term “audio data” refers to applicant response content represented as digital audio signals or audio files, suitable for processing by speech recognition techniques.
The term “video data” refers to applicant response content represented as digital video signals or video files, optionally including synchronized audio and image frames, suitable for processing by image analysis techniques.
The term “speech recognition processing” refers to a computational procedure that takes audio data as input and outputs corresponding text data representing a transcription of spoken content.
The term “natural language processing” refers to a set of computational techniques for analyzing and manipulating text data, including but not limited to tokenization, parsing, sentiment analysis, and keyword extraction.
The term “analysis information” refers to structured data derived from natural language processing or image analysis, including features such as emotion information, keyword information, expression information, and their associated scores or labels.
The term “emotion information” refers to data elements representing an inferred emotional state, polarity, or intensity associated with a text segment, audio segment, or video segment, as determined by computational analysis.
The term “keyword information” refers to data elements representing extracted terms, entities, or phrases that are determined to be salient or relevant within a response or set of responses.
The term “image analysis” refers to a computational procedure that processes video data or still images to detect, recognize, or classify visual features, including facial expressions and other visual cues.
The term “expression information” refers to data elements representing detected facial expressions or other visual indicators from video data, including labels or numeric values corresponding to different types of expressions.
The term “emotion index” refers to a computed metric derived from emotion information, representing an aggregated or normalized measure of emotional characteristics for a question, a time period, or an applicant.
The term “keyword index” refers to a computed metric derived from keyword information, representing aggregated or normalized measures of occurrence, importance, or distribution of specific terms or categories across responses.
The term “aggregating” refers to a process by which raw analysis information from multiple responses or segments is combined, summarized, or statistically processed to derive indices or summary metrics.
The term “visualization data” refers to structured data prepared in a format suitable for direct or near-direct use by a graphical rendering component, including data series, labels, and configuration parameters for charts or other visual elements.
The term “dashboard data” refers to an arrangement of visualization data and display parameters configured to define one or more interactive or static views for presentation on a display interface.
The term “display interface” refers to a user interface environment capable of presenting graphical, textual, or multimedia information on a display device, such as a graphical user interface rendered by a terminal.
The term “evaluator” refers to a human user who reviews dashboard data and analysis results in order to assess an applicant's suitability or performance.
The term “history information” refers to applicant-related background data, such as educational records, work experience summaries, or prior performance data, represented or convertible into digital form and used for tailoring interview questions.
The term “digital data” refers to information represented in a discrete numeric form suitable for storage, transmission, and processing by digital computing devices.
The term “related information” refers to information extracted from history information that is determined to be relevant to interview configuration, question generation, or assessment of an applicant.
The term “additional prompt sentence” refers to a prompt sentence obtained by incorporating related information derived from an applicant's history information into an existing prompt sentence used for controlling a generative AI model.
The term “information processing mechanism” refers to a hardware and software subsystem, such as a computing platform, service, or module, that provides a specific information processing function, including schedule adjustment or workflow management.
The term “schedule-adjustment function” refers to a function that computes and determines time slots or schedules for interviews based on available-time information of one or more participants.
The term “available-time information” refers to structured data representing time periods during which an applicant or evaluator is available for an interview.
The term “interview execution time” refers to a designated time or time interval during which an interview session is scheduled to be conducted.
The term “business-process flow” refers to a defined sequence or network of processing steps, including interview setting, question generation, response acquisition, analysis processing, and presentation of evaluation results.
The term “workflow-management function” refers to a function that controls execution order, concurrency, state transitions, and error handling for a set of processing steps defined within a business-process flow.
The term “interview setting” refers to a configuration operation or processing step in which condition information for an interview, such as interview format and target work role, is defined or selected.
The term “question generation” refers to a processing step in which interview questions are generated based on prompt sentences and outputs from a generative AI model.
The term “response acquisition” refers to a processing step in which response data from an applicant are received, stored, and prepared for analysis.
The term “analysis processing” refers to a group of processing steps that include speech recognition, natural language processing, image analysis, and aggregation of analysis information.
The term “presentation of evaluation results” refers to a processing step in which dashboard data, visualization data, and other summary metrics are transmitted to and displayed on a terminal for review by an evaluator.

Server, terminal, and user cooperate to implement embodiments of the invention. In the following, the term “server” denotes one or more computing devices that provide centralized processing functions, and the term “terminal” denotes a client-side computing device operated by a human user such as an applicant or evaluator.

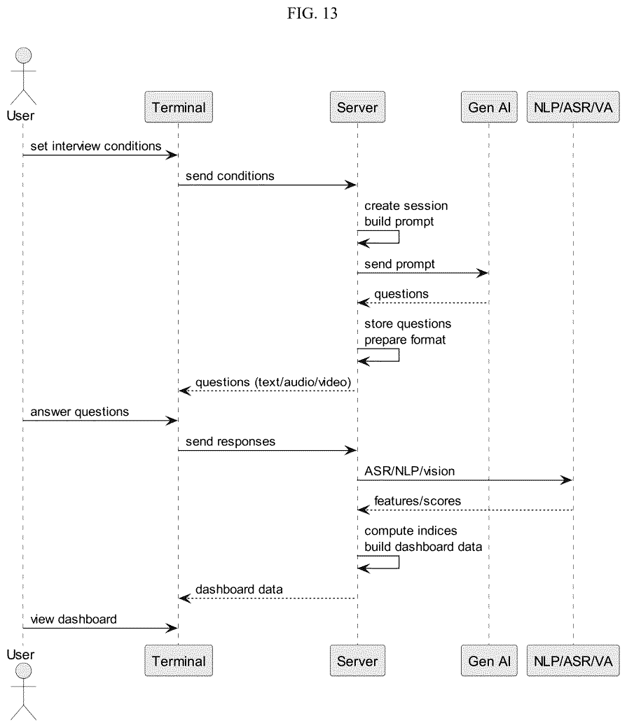

Server executes the program on general-purpose computer hardware. Server uses at least one central processing unit and, in some embodiments, a graphics processing unit for accelerating neural network inference. Server runs an operating system such as a UNIX-like operating system and executes application software including a web application framework (for example, a framework of the type of a Python-based web framework or a JavaScript-based web framework), an HTTP server (for example, a server of the type of a general-purpose web server), and a database management system (for example, a system of the type of a relational database). Server may additionally access external cloud services that provide generative AI models, speech recognition engines, and text-to-speech engines.
Terminal is realized by a computing device such as a smartphone, tablet, or personal computer. Terminal runs an operating system such as a mobile operating system or a desktop operating system and provides a user interface either via a web browser or a dedicated native application. Terminal includes hardware such as a display, a touch panel or keyboard, a microphone, a speaker, a camera, and a network interface.
User operates the terminal to configure and use the system. User may be an administrator who sets up interview templates, an evaluator who reviews dashboards, or an applicant who answers questions.
Server generates and executes a program that manages data structures specifically designed for the automated interview process. Server maintains a configuration datastore including tables or collections for: (i) business-domain information, (ii) job information, (iii) interview format definitions, and (iv) mapping rules from such information to prompt construction parameters. Server also maintains a session datastore, including records for each interview session, with fields such as session identifier, selected interview format, target work role, associated applicant identifier, and timestamps. Server further maintains an analysis datastore storing response texts, extracted features, emotion indices, keyword indices, and aggregated metrics.
Server uses a generative AI model to generate interview questions. In one embodiment, server accesses a large language model deployed on an accelerator-based inference platform. The generative AI model is implemented as a neural network with a transformer architecture including an embedding layer, a plurality of self-attention layers, feed-forward layers, layer normalization components, and output projection layers. The model is trained on large corpora of text using a next-token prediction objective with a cross-entropy loss function. During training, server or an external training platform uses stochastic gradient descent or a variant such as Adam to update model weights. The weights are stored as multidimensional arrays and are optimized to minimize prediction error on training data.
Server does not retrain the generative AI model during normal inference operation; instead, server controls the model's behavior via carefully constructed prompt sentences and optional control parameters such as temperature, top-k, or top-p sampling parameters. By managing these parameters and prompt structure programmatically based on structured condition information, server achieves a technical improvement in controlling the generative AI model compared to manual, ad hoc prompt usage.
Server constructs a prompt sentence based on structured condition information. Server stores mapping rules that convert discrete attributes such as industry category, role level, and competency tags into prompt fragments. Server uses an internal rule engine or template engine that concatenates these fragments with fixed textual patterns. For example, when user selects a leadership-focused role in a management domain, server constructs a prompt sentence such as:
“Generate five open-ended interview questions about leadership for a project manager candidate.”
In another example, when user selects a software development role with emphasis on problem solving and collaboration, server constructs a prompt sentence such as:
“Generate 10 behavioral interview questions for a software engineer role focusing on problem-solving and collaboration.”
In a further example, when user configures an interview for a sales-oriented position, server constructs a prompt sentence such as:
“For a sales manager position, create five interview questions that assess negotiation skills and resilience.”
Server uses these prompt sentences as inputs to the generative AI model. Server sets inference parameters (for example, temperature and maximum token length) so that the model produces a controlled number of questions with sufficient diversity while avoiding excessively long or irrelevant output. By programmatically setting these parameters per-session, server adapts the computational behavior of the model to different interview scenarios, thereby improving the stability and reproducibility of the generated content. Server further refines prompt sentences by incorporating applicant-specific history information. Server first converts applicant history information, such as text-based resumes or structured profile records, into normalized digital data. Server uses a natural language processing pipeline including tokenization, part-of-speech tagging, and named-entity recognition to extract related information such as technical skills, leadership experiences, and domain-specific terms. Server then injects these extracted elements into additional prompt segments. For instance, server constructs an additional prompt sentence such as:
“Considering that the candidate has experience leading cross-functional teams in product development, generate five interview questions that focus on leadership in cross-functional environments.”
By embedding applicant-specific features into the prompt sentence, server causes the generative AI model to generate questions that are technically aligned with the candidate's profile. This structured interaction between the feature extraction pipeline and the prompt-generation module yields a more fine-grained and parameterized control over the generative model, which is a technical improvement over systems where generative models are driven by unstructured, manually written prompts.
Server also controls multimodal data acquisition and normalization. When terminal captures audio responses, terminal uses its microphone and audio subsystem to record the applicant's voice. Terminal encodes the captured signal using a codec such as a waveform or a compressed audio format and transmits the encoded data to server via a secure communication protocol. When terminal captures video responses, terminal uses its camera and video subsystem to capture synchronized audio and image frames, encodes them using video and audio codecs, and transmits the encoded stream or file to server.
Server receives these media streams and stores them in a media storage module, which may include local storage and/or remote object storage. Server records metadata such as session identifier, question identifier, capture timestamps, and media format information. Server then executes conversion processes that normalize the media into formats optimized for analysis. For audio data, server resamples or re-encodes the stream to a predetermined sampling rate and bit depth, which improves the robustness and accuracy of subsequent speech recognition. For video data, server extracts key frames at time intervals aligned with question boundaries, which reduces the volume of frames processed by image-analysis modules and thereby reduces computational cost and latency.
Server performs speech recognition on audio data using a speech recognition engine. The engine may be an external service accessed over a network or a local neural network model. In one embodiment, the speech recognition model is a sequence-to-sequence neural network that includes an acoustic model, a language model, and a decoder. The acoustic model transforms acoustic feature sequences (for example, Mel-frequency cepstral coefficients) into probability distributions over phoneme or grapheme units. The decoder applies beam search to select the most probable text sequence given the acoustic model output and the language model. By pre-processing the audio into a consistent format and using optimized decoding parameters, server reduces recognition errors and improves processing throughput.
Server uses natural language processing on text data to derive analysis information. Server may use a sentiment-analysis model that assigns polarity scores and intensity scores to phrases and sentences. The sentiment-analysis model can be implemented as a neural network, such as a transformer-based classifier fine-tuned on labeled sentiment data, with a softmax output layer that yields probabilities over sentiment categories. Server also uses keyword-extraction methods, such as attention-based scoring, TF-IDF scoring, or keyphrase extraction algorithms, to identify salient terms related to leadership, teamwork, problem solving, and other attributes. Server stores, for each answer, a vector of features including sentiment scores, salience scores, and keyword identifiers.
Server performs image analysis on video frames to extract expression information and emotion information. Server uses a vision model, such as a convolutional neural network or a transformer-based vision model, trained on facial expression datasets. The model outputs probabilities for different expression categories (for example, happiness, confusion, stress) and may also detect facial landmarks, head pose, and gaze direction. Server aggregates these outputs over time intervals corresponding to each question, computing average probabilities, variance measures, and transition metrics between expressions. Server stores these aggregated features in the analysis datastore.
Server computes emotion indices and keyword indices based on stored analysis features. Server defines index calculations as deterministic algorithms that combine multiple feature values with weights. For example, an emotion index per question can be computed as a weighted sum of sentiment polarity, emotion probabilities from video frames, and acoustic cues derived from prosodic analysis (such as pitch variation and speaking speed). A keyword index can be computed by counting the frequency and weighted importance of certain domain-specific terms. By defining these indices via explicit formulas implemented as numerical computation routines, server ensures predictable, reproducible metrics that differ from subjective human impressionistic scoring.
Server aggregates indices across questions and applicants using data structures designed for efficient retrieval and visualization. Server maintains per-question records with fields for emotion index, keyword index, time duration, and confidence measures, and per-applicant summary records with aggregates such as averages, medians, and distributions. Server uses index-based queries and precomputed aggregates to supply dashboard data with low latency, reducing the need for expensive ad hoc computations at display time. This leads to an improvement in responsiveness and scalability compared to systems that compute metrics on the fly for each dashboard request.
Server generates visualization data that is structured for direct rendering by front-end visualization components. Server converts indices and features into arrays of numeric values, label strings, and configuration parameters for chart types such as line graphs, bar charts, and radar charts. Server annotates each data series with identifiers that correspond to questions, time segments, or applicants, enabling interactive filtering and comparison on the terminal side. By maintaining a stable schema for visualization data, server simplifies client-side rendering logic and reduces network bandwidth through compact, structured messages. Terminal receives visualization data and renders an interactive dashboard. Terminal uses a graphical user interface toolkit or a web-based visualization library to draw charts, tables, and summaries on the display. Terminal allows evaluator interaction such as selecting particular questions, sorting candidates, or filtering by role. Terminal sends interaction events back to server as requests containing query parameters. Server uses these parameters to perform targeted queries on the analysis datastore and returns updated visualization data. This round-trip interaction is supported by an optimized data and index design, which reduces the number of records scanned and therefore reduces server-side CPU usage and response times. Server improves computer technology beyond mere automation of human tasks by implementing specific data structures, algorithms, and neural network control mechanisms that change how the computing system processes and stores information. By converting heterogeneous, multimodal responses into normalized intermediate representations and by computing structured indices, server enables efficient machine-level comparison and retrieval that could not be reliably performed with raw media or unstructured logs. The use of programmatically generated prompt sentences, driven by structured condition information and applicant features, constitutes a technical method for configuring a generative AI model, yielding deterministic and reproducible behavior that is distinct from non-technical manual prompting.
Server further reduces communication and storage overhead by selectively extracting key frames from video and by storing compressed, feature-based representations alongside raw media. When evaluator requests summary-level views, server can respond using only aggregated indices and visualization data without transmitting heavy media files, thereby reducing network load and improving page load times. When deeper review is requested, server can reference underlying media via identifiers that allow selective streaming rather than bulk transfer.
Server also improves computational efficiency by organizing processing into modular pipelines with well-defined interfaces, such as a prompt-construction module, generative-question module, speech-processing module, text-analysis module, image-analysis module, and aggregation module. Each module uses specialized algorithms and can be deployed on hardware suited to its workload (for example, running generative models on GPU-accelerated nodes and running data aggregation on CPU-optimized nodes). Such modularization and hardware-aware deployment yield better resource utilization and throughput than monolithic, unstructured implementations.
User benefits from these technical improvements through more consistent and faster system responses, but the improvements themselves are realized at the level of data structures, processing pipelines, and neural network control logic within the computing environment. Server imposes specific, non-conventional sequences of transformations on data—structured condition information to prompt sentences, prompt sentences to generative outputs, generative outputs to multimodal presentations, multimodal recordings to structured features, and structured features to indexed aggregates—that collectively result in reduced error rates, improved processing speed, and enhanced manageability of large interview datasets.
Server and terminal can be implemented in various alternative embodiments. In one embodiment, server uses an external generative AI platform and external speech and vision services, coordinating them through an orchestration engine. In another embodiment, server hosts local models for generative text and speech processing to reduce external dependency and latency. In yet another embodiment, terminal performs partial preprocessing, such as on-device noise reduction or basic keyword spotting, before transmitting data to server, further reducing bandwidth usage and server load. In all cases, the core concepts of structured prompt construction, multimodal normalization, feature-based indexing, and visualization-oriented aggregation remain applicable and define the technical essence of the implemented invention.
The following describes the processing flow using FIG. 13.

### Step 1:

User configures interview conditions on the terminal.
User operates the terminal to select an interview format (text, audio, or video) and a target work role, and optionally selects industry and competency tags via a graphical user interface. The input of this step is user interaction events (touches, clicks, and selected values), and the output of this step is structured condition information, such as a set of fields representing interview format, target role, industry category, and required skills. Terminal converts the user selections into a structured representation and prepares them for transmission to the server.

### Step 2:

Terminal transmits condition information to the server.
Terminal packages the structured condition information into a request message and sends it to the server over a network connection. The input of this step is the condition information generated in Step 1, and the output is a network request containing this condition information. Terminal performs data encoding, such as serializing the condition information into a standardized format, and then transmits the encoded data to a designated interface of the server.

### Step 3:

Server stores session data and normalizes condition information.
Server receives the request, extracts the condition information, and creates a new interview session record in a session datastore. The input of this step is the transmitted condition information, and the output is a stored session record with a unique session identifier and normalized condition fields. Server normalizes the condition information by mapping user-facing labels (for example, role names and industry names) to internal codes and by validating that the selected format and role are supported, thereby generating standardized internal parameters for subsequent processing.

### Step 4:

Server generates a base prompt sentence for the generative AI model.
Server reads the normalized condition fields from the session record and applies a rule-based or template-based generator to construct a base prompt sentence. The input of this step is the normalized condition information, and the output is a base prompt sentence written in natural language. Server executes data concatenation and substitution operations that insert role-specific and competency-specific phrases into pre-defined text templates, thereby transforming discrete internal codes into a coherent prompt sentence suitable for the generative AI model. For example, server generates a base prompt sentence such as “Generate five open-ended interview questions about leadership for a project manager candidate.”

### Step 5:

Server refines the prompt sentence using applicant history information.
Server accesses digital representations of the applicant's history, such as resume text and profile records, and processes these with a natural language analysis module to extract related information like prior leadership roles or domain expertise. The input of this step is the base prompt sentence and the applicant history data, and the output is an additional prompt sentence that includes applicant-specific elements. Server performs tokenization, entity extraction, and relevance scoring on the history data, selects salient features, and incorporates them into the base prompt sentence by appending or inserting descriptive clauses, thereby generating a refined prompt sentence that adapts the generative AI model to the applicant's characteristics.

### Step 6:

Server invokes the generative AI model using the refined prompt sentence.
Server sends the refined prompt sentence and control parameters (such as maximum output length and sampling parameters) to the generative AI model and receives generated text containing interview questions. The input of this step is the refined prompt sentence and generation parameters, and the output is a text block representing a plurality of interview questions. Server transmits the prompt sentence to the model, triggers neural network inference on the model's layers, and receives the model's token outputs, which are then decoded into natural-language questions.

### Step 7:

Server parses and stores generated interview questions.
Server processes the returned text block to isolate individual questions and stores each question in a question datastore linked to the session. The input of this step is the generated text from the generative AI model, and the output is a structured set of question records with identifiers, text content, and ordering information. Server performs text segmentation based on delimiters such as line breaks or numbering, trims extraneous characters, and assigns sequential indices to each question, thereby converting a raw text sequence into a normalized question list.

### Step 8:

Server selects presentation formats and prepares question content.
Server reads the selected interview format and determines whether questions should be delivered as text, audio, video, or a combination. The input of this step is the question records and the format information from the session, and the output is format-specific question payloads. Server transforms the question text into different media representations: for text format, server arranges questions into structured text blocks; for audio format, server sends question text to a text-to-speech engine and receives corresponding audio data; for video format, server may combine question text or audio with visual elements. In each case, server associates generated media with question identifiers and prepares them for transmission.

### Step 9:

Server sends prepared question content to the terminal.
Server packages the format-specific question payloads into response messages and transmits them to the terminal. The input of this step is the prepared question content, and the output is network responses containing questions in one or more formats. Server performs data packaging and, in the case of media, may include references to media locations or streaming endpoints, thereby enabling the terminal to retrieve and present the questions efficiently.

### Step 10:

Terminal presents questions to the applicant.
Terminal receives the question content and renders it on the user interface according to the specified format. The input of this step is the question payload delivered by the server, and the output is visual, auditory, or audiovisual presentations to the applicant. Terminal executes UI rendering operations such as drawing text on the display, playing audio through the speaker, or displaying video alongside text prompts, and synchronizes these presentations with control elements for recording responses.

### Step 11:

User (applicant) provides responses via the terminal.
User listens to or reads each question and enters a response by typing, speaking, or speaking while being recorded by the camera, depending on the selected format. The input of this step is the question presented by the terminal, and the output is raw response data captured by the terminal in the form of text input, audio signals, or video signals. Terminal converts input events and sensor signals into digital data streams and temporarily stores them for transmission.

### Step 12:

Terminal transmits response data to the server.
Terminal encodes the captured responses, for example by transforming text input into a structured message or encoding audio and video into designated media formats, and then sends them to the server. The input of this step is the raw response data captured in Step 11, and the output is one or more request messages containing encoded response data and associated metadata such as question identifiers and timestamps. Terminal performs compression, packaging, and network transmission to deliver the responses securely and reliably.

### Step 13:

Server stores and normalizes response data.
Server receives the response messages, extracts the response payloads and metadata, and writes them into a response datastore. The input of this step is the encoded response data from the terminal, and the output is normalized response records, each linked to a session and question. Server converts incoming formats into standardized internal formats, such as UTF-8 text for typed answers and uniform container formats for audio and video, and assigns status fields indicating whether further analysis is pending.

### Step 14:

Server performs speech recognition on audio responses.
Server identifies response records containing audio data and submits the audio segments to a speech recognition component. The input of this step is the stored audio data and associated metadata, and the output is transcribed text data for each audio response. Server pre-processes the audio by resampling and normalizing amplitude, extracts acoustic features, and passes them through the recognition model, which returns text sequences; server then links these text sequences back to the corresponding response records as recognized text.

### Step 15:

Server performs natural language processing on text responses.
Server selects both originally typed responses and transcribed audio responses and processes their text content using a natural language analysis pipeline. The input of this step is text data representing applicant responses, and the output is analysis information including emotion information and keyword information for each response. Server tokenizes the text, applies a sentiment classifier to obtain sentiment scores, and applies keyword-extraction algorithms to identify salient terms and entities, thereby transforming unstructured text into structured feature vectors.

### Step 16:

Server performs image analysis on video responses.
Server identifies response records containing video data and extracts representative frames or short sequences associated with each question. The input of this step is the stored video data and segment boundaries, and the output is expression information and emotion information for each response. Server decodes video frames, applies a facial detection and expression-recognition model to each frame, and aggregates frame-level predictions into response-level statistics, thereby converting visual content into quantifiable features.

### Step 17:

Server computes emotion indices and keyword indices.
Server combines the analysis features derived from text, audio, and video for each response and computes standardized indices. The input of this step is the set of emotion-related scores, keyword-related scores, and other features per response, and the output is an emotion index and a keyword index associated with each question and each applicant. Server executes numerical operations such as weighted summation, normalization, and scaling to generate indices that represent consolidated measures suitable for comparison and aggregation.

### Step 18:

Server aggregates indices over questions and applicants.
Server performs aggregation across multiple responses to compute summary metrics per question and per applicant. The input of this step is the per-response emotion and keyword indices, and the output is aggregated metrics such as average emotion index per question and overall keyword index per applicant. Server applies grouping and statistical functions, such as averaging and variance calculations, to transform granular indices into higher-level summaries stored in dedicated aggregate records.

### Step 19:

Server constructs visualization data for dashboards.
Server converts the aggregated metrics and selected underlying indices into visualization-oriented data structures. The input of this step is the aggregated and per-question metrics, and the output is visualization data such as data series, labels, and configuration attributes for charts and tables. Server arranges metrics into arrays aligned with question identifiers or time sequences, assigns color mappings or chart types, and associates labels with numeric values, thereby preparing compact, structured data specifically for rendering.

### Step 20:

Server transmits dashboard data to the terminal.
Server packages the visualization data into response messages directed to an evaluator terminal. The input of this step is the visualization-oriented data structures, and the output is a transmission containing dashboard data ready for display. Server formats the data according to a predefined schema and sends it via the communication path, ensuring that all necessary parameters for chart rendering and table display are included.

### Step 21:

Terminal renders and updates the evaluation dashboard for the user.
Terminal receives the dashboard data and renders interactive visual components on the display for the evaluator. The input of this step is the dashboard data from the server, and the output is a displayed dashboard showing charts, tables, and summary indicators. Terminal interprets the visualization data, invokes drawing routines for graphs and UI components, and updates the display. When the user performs interactions such as filtering or drilling down into details, terminal converts these interactions into new requests to the server, thus enabling iterative refinement of the presented evaluation based on the structured data generated by the preceding steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interview and screening systems typically treat audio, video, and textual information as separate data streams processed by loosely coupled software components. In many deployments, question lists are authored manually, answers are evaluated qualitatively by human reviewers, and basic speech-to-text engines are used merely to create transcripts. Such architectures exhibit several technical drawbacks.

First, conventional systems generally do not provide a unified control flow in which a processor systematically constructs prompt sentences, invokes a generative AI model, and feeds back the model's outputs into subsequent low-level signal processing stages. As a result, interview questions are not dynamically tailored based on structured resume information and prior analysis results, and the overall processing pipeline cannot adapt in real time to the evolving state of an interview session.
Second, conventional systems tend to process acoustic features, facial expression features, and linguistic content in isolation, with minimal integration at the processor level. Audio analysis components may compute pitch or energy curves, and image analysis components may detect facial landmarks, but these features are not consistently fused with natural language analysis and generative AI evaluations to yield machine-interpretable scores such as emotion state information, answer confidence information, truthfulness information, and candidate placement information. This fragmented architecture leads to inefficient data transfers between subsystems, duplicated computations, and increased latency when handling multi-modal interview streams.
Third, traditional interview platforms lack a processor-level mechanism to automatically generate alerts and supplemental question instructions when derived emotion or truthfulness measures satisfy particular conditions. In many systems, any anomaly detection is performed manually by a human operator viewing raw video or reading text, which imposes cognitive load, introduces variability, and prevents deterministic, rule-driven behavior by the computing system itself.
Fourth, scheduling and workflow control for interview and hiring operations are often managed outside the core analysis system, for example by separate calendar or workflow tools. There is no integrated processor-controlled mechanism that binds evaluation information and system-generated recommendations to automatic schedule generation, stage transitions, and interview operator notifications. This separation leads to increased network calls, redundant storage updates, and inconsistent state across systems.
Accordingly, there is a need for a system in which a processor is specifically configured to (i) generate interview questions by programmatically constructing prompt sentences and invoking a generative AI model, (ii) acquire and transform resume, audio, and video information into unified, structured representations, (iii) integrate multi-modal feature extraction with generative AI-based content evaluation to compute machine-interpretable evaluation information in real time or quasi real time, and (iv) automatically drive alert generation, supplemental questioning, scheduling, and workflow transitions based on that evaluation information. By addressing these issues, the present invention improves the functioning of a computer-implemented interview and screening system itself, reduces processing latency and operator workload, and enables more efficient and technically coherent handling of complex multi-modal data streams.

The specific processing by the specific processing unit 290 of the data processing device 12 in Application Example 2 is realized by the following means.

The present invention provides a server comprising a processor configured to receive job category information, job type information, and role information, and to input a prompt sentence to a generative AI model so as to cause the generative AI model to generate interview question information corresponding to the job category information, the job type information, and the role information; to acquire applicant history information data or image information data, to execute character recognition processing and natural language processing on the applicant history information data or the image information data to extract work information, skill information, and experience information, and to input a prompt sentence including an extraction result to the generative AI model so as to cause the generative AI model to generate additional interview question information specialized for an applicant; to acquire audio information obtained during an interview, to execute speech recognition processing on the audio information to convert the audio information into text information, to execute acoustic analysis processing on the audio information to extract audio feature amounts including pitch information, volume information, and speaking rate information, to execute image analysis processing on video information obtained during the interview to extract image feature amounts including expression information, and to estimate emotion state information and answer confidence information by using the audio feature amounts and the image feature amounts; to integrate a response content evaluation result obtained by the generative AI model, the emotion state information, and the answer confidence information to calculate aptitude information, truthfulness information, and candidate placement information of the applicant, and to output the aptitude information, the truthfulness information, and the candidate placement information as evaluation information; to generate evaluation screen information in which the evaluation information is visualized, and to transmit the evaluation screen information to a terminal device including a display so that the evaluation screen information is presented in real time or quasi real time during or after the interview; and to determine that the emotion state information or the truthfulness information satisfies a predetermined condition, and to generate alert information or supplemental question instruction information, and to transmit the alert information or the supplemental question instruction information to the terminal device so that the alert information or the supplemental question instruction information is presented to an interview operator or a monitoring operator. This enables the computer-implemented interview and screening system to execute an integrated multi-modal processing pipeline, to dynamically generate and adapt interview questions through prompt-based interaction with the generative AI model, to compute structured evaluation information from combined textual, acoustic, and visual features with reduced latency, and to automatically control alerts, supplemental questioning, scheduling, and workflow transitions in a manner that improves the overall technical performance and autonomy of the system.

The term “job category information” refers to information indicating a classification of an economic or business sector in which a position or organization operates.
The term “job type information” refers to information indicating a classification of a kind of work or occupation based on tasks or responsibilities.
The term “role information” refers to information indicating a specific functional responsibility or position to be assumed by an individual within an organization.
The term “prompt sentence” refers to a natural-language instruction string input to a generative AI model to control generation of output data such as interview questions or evaluation text.
The term “generative AI model” refers to a computational model that generates output data, including natural-language text, based on input data and learned parameters.
The term “interview question information” refers to data representing one or more questions intended to be presented during an interview session.
The term “applicant history information data” refers to electronic data representing background information of a candidate, including past employment, education, skills, and experience.
The term “image information data” refers to electronic data representing visual content, including still images or moving images associated with an applicant.
The term “character recognition processing” refers to processing that converts image information containing characters into machine-readable text data.
The term “natural language processing” refers to processing that analyzes text data in a human language to extract structured information such as entities, attributes, and relationships.
The term “work information” refers to information related to past or present job positions, duties, and responsibilities of an applicant.
The term “skill information” refers to information indicating technical abilities or competencies possessed by an applicant.
The term “experience information” refers to information indicating past activities, projects, or durations of practice relevant to an applicant.
The term “additional interview question information” refers to data representing questions that are generated in addition to initial questions and that are specialized for a particular applicant.
The term “audio information” refers to electronic data representing sound signals including spoken utterances during an interview.
The term “speech recognition processing” refers to processing that converts audio information representing speech into text information.
The term “text information” refers to electronic data representing character strings in a human language.
The term “acoustic analysis processing” refers to processing that analyzes audio signals to extract quantitative features such as frequency, intensity, and temporal characteristics.
The term “audio feature amounts” refers to numerical values representing properties of an audio signal, including pitch, loudness, and speaking rate.
The term “pitch information” refers to information indicating a perceived fundamental frequency of a speech signal.
The term “volume information” refers to information indicating an amplitude or loudness level of a speech signal.
The term “speaking rate information” refers to information indicating a speed at which words or syllables are produced in speech.
The term “video information” refers to electronic data representing time-varying visual images recorded during an interview.
The term “image analysis processing” refers to processing that analyzes video information or still images to extract features such as shapes, positions, or expressions.
The term “image feature amounts” refers to numerical values representing properties of visual data, including positions or movements of facial components.
The term “expression information” refers to information indicating a facial expression state such as happiness, sadness, anger, surprise, or neutrality.
The term “emotion state information” refers to information representing an estimated psychological or affective state of an applicant derived from multi-modal data.
The term “answer confidence information” refers to information representing an estimated degree of confidence with which an applicant provides an answer.
The term “response content evaluation result” refers to information representing an assessment of an answer's content generated by a generative AI model or other evaluation logic.
The term “aptitude information” refers to information indicating an estimated suitability of an applicant for a particular job category, job type, or role.
The term “truthfulness information” refers to information indicating an estimated likelihood that a statement or answer by an applicant is accurate or consistent with known data.
The term “candidate placement information” refers to information indicating one or more recommended organizational units or positions suitable for assignment of an applicant.
The term “evaluation information” refers to composite information including aptitude information, truthfulness information, and candidate placement information derived from analysis of interview data.
The term “evaluation screen information” refers to information defining a graphical user interface layout or screen content that visualizes evaluation information for display on a terminal.
The term “terminal device” refers to an electronic device including at least a display and communication capability used by an interview operator or monitoring operator to interact with the system.
The term “alert information” refers to information indicating that a predetermined condition related to an emotion state or truthfulness has been satisfied and that attention or intervention is required.
The term “supplemental question instruction information” refers to information instructing presentation of one or more additional questions in response to a detected condition during an interview.
The term “interview operator” refers to a person responsible for conducting, supervising, or reviewing an interview using the system.
The term “monitoring operator” refers to a person responsible for monitoring interview sessions or security-related interactions using the system.
The term “scheduling function” refers to a processing function that manages schedule information and automatically generates, updates, and notifies appointment data related to interviews.
The term “workflow management function” refers to a processing function that manages task states, progress, and evaluation data in a hiring workflow and controls transitions between process stages.
In the following embodiments, a server, one or more terminals, and one or more users cooperate to implement an interview and screening system according to the claims. The server executes machine-readable programs stored in a non-transitory storage medium. The programs control a processor, a main memory, and one or more hardware accelerators such as graphics processing units so as to perform generative AI model invocation, multimodal signal processing, and evaluation information generation.

### A. Hardware and Software Configuration

The server includes at least one processor, a main memory, a storage device, a network interface, and, in some embodiments, a hardware accelerator. The server executes an operating system and application programs including:
A generative AI model execution module implementing a text generation neural network (for example, a Transformer decoder network) as a generative AI model.
A natural language processing module implementing tokenization, part-of-speech tagging, dependency parsing, and named entity recognition.
A speech recognition interface module configured to communicate with an external speech-to-text engine.
An acoustic analysis module configured to compute acoustic feature vectors from audio signals.
An image analysis module configured to detect faces and extract expression features from video frames.
An emotion estimation module implemented as a neural network for multimodal feature fusion.
An evaluation module implemented as a statistical learning model.
A scheduling module and a workflow management module implemented as data-processing components operating on structured schedule data and workflow state data.
   The terminal is realized as a general-purpose computing device such as a mobile computing device, a head-mounted display device, or a desktop computing device. The terminal includes a processor, a memory, a display, a microphone, and a camera. The terminal runs a client application that renders user interfaces, acquires user input, captures audio and video, and exchanges data with the server via a network.
   The user operates the terminal through graphical user interface components to enter job category information, job type information, role information, and applicant identification information, and to start or supervise interview sessions.

### B. Data Structures

The server stores the following example data structures in a database or in memory:
A job profile record including fields for job category information, job type information, and role information.
An applicant profile record including fields for applicant history information data (for example, resume text), extracted work information, skill information, and experience information.
A question set object including multiple items of interview question information and additional interview question information, each item tagged with a question identifier and a question type.
An audio feature vector matrix in which each row corresponds to an answer segment and contains audio feature amounts such as pitch, volume, and speaking rate.
An image feature vector matrix in which each row corresponds to a time segment and contains expression information encoded as numeric values.
An emotion and confidence record including emotion state information and answer confidence information per answer.
An evaluation record including aptitude information, truthfulness information, and candidate placement information.
A screen definition record representing evaluation screen information, including layout metadata and references to data fields to be visualized.
A schedule record managed by the scheduling function and a workflow state record managed by the workflow management function.
   By defining these explicit data structures, the server constrains internal data flow and reduces redundant parsing, which improves cache locality and processing throughput compared to unstructured, ad hoc representations.

### C. Generative AI Model and Training

The server implements the generative AI model as a multi-layer Transformer network with an embedding layer, multiple self-attention layers, feed-forward sublayers, and an output projection layer. The server uses subword tokenization to represent prompt sentences and generated text as sequences of token identifiers.
The server pre-trains the generative AI model on a large text corpus to learn generic language patterns and then fine-tunes the model on an interview-specific corpus including historical question sets, evaluation comments, and interview scripts. The server uses a cross-entropy loss function between predicted token distributions and reference tokens and updates network weights using a gradient-based optimizer such as an adaptive moment estimation algorithm. The server performs minibatch training and uses learning-rate scheduling and dropout regularization to improve generalization.
The server similarly trains the emotion estimation module as a multimodal neural network. The server defines an input layer that receives a concatenation of audio feature amounts (for example, mean pitch, pitch variance, mean intensity, speaking rate) and image feature amounts (for example, expression probabilities and facial action scores). The server connects the input layer to several fully connected layers with non-linear activation functions. The server defines an output layer that produces probability distributions over discrete emotion states and continuous answer confidence values. The server trains this model using labeled multimodal interview clips, a loss function combining categorical cross-entropy for emotion labels and mean-squared error for confidence values, and back-propagation with gradient descent.
By specifying the architectures, loss functions, and update rules, the system constrains the internal behavior of the models and produces deterministic, machine-optimized mappings from multimodal input to evaluation information, which is distinct from human mental evaluation.

### D. Prompt Sentence Construction and Question Generation

The server receives job category information, job type information, and role information from the terminal and creates a job profile record. The server also acquires applicant history information data or image information data representing a resume or similar document. When the input is image information data, the server uses a character recognition library to convert the image into text. The server then uses the natural language processing module to extract work information, skill information, and experience information and to populate corresponding fields in the applicant profile record.
The server constructs a prompt sentence for question generation by inserting the job profile fields and the extracted applicant fields into a pre-defined template. For example, the server may generate the following prompt sentence:
“Generate eight technical and four behavioral interview questions for a backend engineer in the finance sector. The candidate has 5 years of Java and microservices experience and has led 2 projects. Focus on depth of Java knowledge and leadership.”
The server tokenizes this prompt sentence, feeds the token sequence to the generative AI model, and obtains generated text. The server post-processes the text to separate it into individual interview question information items. The server assigns identifiers and types to each question and stores the resulting question set object. The server thereby transforms a high-level natural-language specification into a structured set of machine-usable questions in a repeatable manner.
Because the server uses the extracted skill information and experience information to specialize the prompt sentence, the generated questions are adapted not only to the job profile but also to each applicant's background. This structured, programmatic prompt construction improves the relevance of generated questions while limiting the number of model calls, thus reducing network traffic and processing time compared to naive repeated manual queries.

### E. Multimodal Feature Extraction

The terminal acquires audio information and video information during an interview and sends the data to the server. The server segments the streams based on timestamps associated with each question and answer pair.
For each audio segment, the server uses a speech-to-text engine to perform speech recognition processing and obtain text information. The server then uses an acoustic analysis library to compute audio feature amounts from the audio signal. The server may compute features such as fundamental frequency trajectories, short-term energy, spectral tilt, jitter, shimmer, and speaking rate. The server aggregates frame-level measurements into per-segment statistics and stores them in the audio feature vector matrix.
For each video segment, the server decodes video frames and uses an image analysis library to detect faces. The server computes image feature amounts such as probabilities for several facial expression categories and parameters corresponding to facial muscular activation. The server stores these feature vectors in the image feature vector matrix.
By computing and storing these feature vectors in fixed-length numeric arrays, the system reduces the dimensionality of raw audio and video and allows downstream models to operate on compact, cache-friendly data. This reduces memory bandwidth consumption and accelerates emotion estimation compared to repeated access to full-resolution media.

### F. Emotion State and Answer Confidence Estimation

The server feeds concatenated audio and image feature vectors into the emotion estimation module. The server uses a forward pass of the trained neural network to obtain probability values representing emotion state information and continuous values representing answer confidence information for each answer segment.
The server may apply threshold rules to convert probabilities into discrete emotion labels and to detect conditions such as “high stress” or “low confidence.” The server stores the results in the emotion and confidence record. Because the module has been trained with multimodal inputs, the server can detect subtle patterns that are not easily observed in a single modality, such as an increase in speaking rate combined with a brief micro-expression, which correlates with nervousness.
By using a specialized neural network and structured feature vectors, the system achieves higher classification accuracy and lower false positive rates compared to conventional heuristic thresholds applied only to pitch or loudness.

### G. Content Evaluation and Truthfulness Estimation

The server uses the text information obtained by speech recognition as input to the natural language processing module and to the generative AI model. The server compares named entities and numerical expressions in the answer transcripts with those in the applicant history information data and computes an inconsistency score based on mismatched values and missing items.
The server formulates a prompt sentence that includes the answer text, extracted resume excerpts, and the inconsistency score. For example, the server may use a prompt sentence such as:
“Analyze the following answer and the resume details. The resume indicates 3 years of backend experience, while the answer states 10 years. Estimate truthfulness, depth of expertise, and suitability for a backend engineer role.”
The server sends this prompt sentence and the referenced texts to the generative AI model. The generative AI model outputs a textual assessment, which the server converts into numeric truthfulness information and content quality scores using predefined parsing rules and normalizing functions. The server thereby generates response content evaluation results that incorporate both deterministic resume comparison and probabilistic language modeling. Because the server combines explicit rule-based consistency checks with generative model-based semantic evaluation, the truthfulness estimation becomes less sensitive to purely stylistic differences and more robust against minor transcription errors. This combined algorithmic approach reduces ambiguity compared to human-only judgment and generic sentiment analysis.

### H. Evaluation Information Generation and Visualization

The server integrates aptitude information, truthfulness information, and candidate placement information into the evaluation record. The server obtains aptitude information by applying an evaluation model implemented as a machine-learning classifier or regressor that operates on a feature vector consisting of content quality scores, emotion state information, and answer confidence information.
The server trains this evaluation model using historical labeled data, where labels represent hiring outcomes and department assignments. The server uses a loss function such as log-loss or mean-squared error and updates parameters using gradient-based training. This model, running on structured evaluation features, produces continuous suitability scores and recommended organizational units.
The server generates evaluation screen information by binding fields from the evaluation record to layout definitions in the screen definition record. The server encodes the screen as structured data describing charts, tables, and color-coded indicators. The terminal receives this information and renders it using a graphical framework. The terminal may display, for example, a timeline of emotion levels, a bar chart of aptitude per competency, and a list of recommended departments.
Because the server delivers pre-aggregated, pre-formatted evaluation screen information instead of raw metrics, the terminal can render complex dashboards with minimal local computation, thus reducing client-side processing load and network round-trips.

### I. Alert Generation and Supplemental Questions

The server monitors emotion state information and truthfulness information during the session. When a value crosses a predetermined threshold or a pattern such as sustained low confidence is detected, the server generates alert information or supplemental question instruction information.
The server constructs a further prompt sentence for the generative AI model when supplemental questions are needed. For example, the server may use:
“Generate two short follow-up questions to clarify the candidate's claim about leading a large project, given that confidence appears low and inconsistencies exist with the resume.”
The server obtains the generated questions, converts them into additional interview question information, and includes them in a message to the terminal together with alert information. The terminal presents the alert visually and either automatically or under operator control presents the supplemental questions to the user.
This closed-loop behavior, in which multimodal evaluation directly controls generative question refinement, creates a feedback mechanism that adapts the computer-controlled interview process in real time. As a result, the system can collect more discriminative data for subsequent evaluation, which improves the accuracy of aptitude and truthfulness estimation compared to a fixed, non-adaptive script.

### J. Scheduling and Workflow Integration

The server uses the scheduling function to manage schedule records for interview operators and applicants. The server automatically creates and updates time slots based on evaluation information, such as scheduling additional technical interviews only when aptitude information exceeds a threshold. The server communicates with the terminal to deliver notifications.
The server uses the workflow management function to update workflow state records as evaluation information is generated. For example, the server automatically transitions a candidate from an “initial screening” state to a “final review” state when both aptitude information and truthfulness information satisfy conditions. These transitions cause the server to invoke specific processing paths, such as generating different types of prompt sentences for later-stage interviews.
Because scheduling and workflow updates are controlled by the same processor that executes evaluation logic and generative AI model interactions, the system maintains a consistent internal state without relying on external manual synchronization. This reduces race conditions, stale data, and redundant communication.

### K. Technical Effects and Improvements

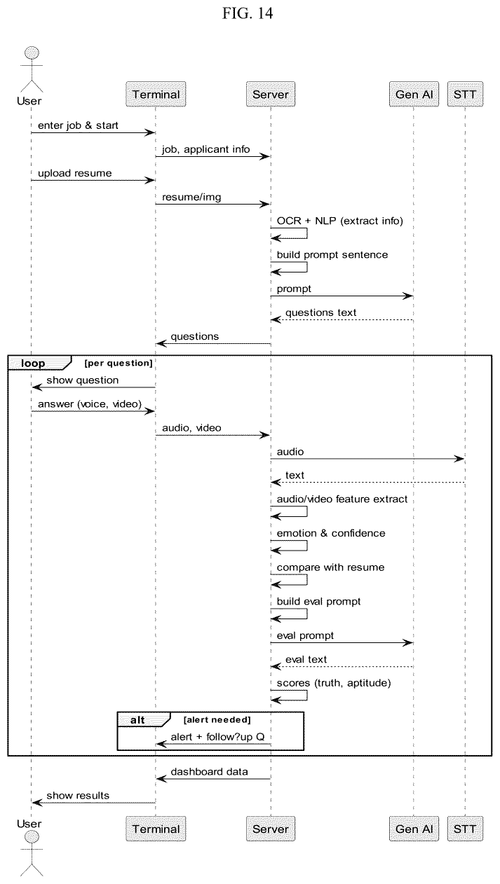

By structuring the processing in the above manner, the server achieves several technical improvements:
The server reduces overall processing latency by using compact feature vectors and by unifying multimodal analysis and generative model invocation within a single processor-controlled pipeline.
The server improves accuracy of emotion and truthfulness estimation by training specialized neural networks on fused acoustic and visual features and by combining explicit rule-based consistency checking with semantic evaluation through generative AI models.
The server improves data management by storing evaluation-related data in well-defined records and matrices, which reduces parsing overhead and memory fragmentation during high-volume interview sessions.
The server reduces communication load by sending structured evaluation screen information instead of raw media or unstructured logs, thereby lowering bandwidth usage.
The server improves computational efficiency by reusing extracted features across multiple models (emotion estimation, evaluation scoring, alert detection) and by avoiding redundant processing of raw audio and video.
   These technical effects arise from specific data structures, algorithms, and neural network architectures implemented in the system and are not a mere automation of human mental processes. The processor executes defined numerical operations on digital signals and structured data, using trained models, loss functions, and update rules, to produce evaluation information and control outputs that adapt subsequent machine behavior. This yields a computer-implemented system whose internal operation is technically improved compared to conventional interview tools and generic data-processing pipelines.
   The following describes the processing flow using FIG. 14.

### Step 1:

The user operates the terminal to input job category information, job type information, role information, and applicant identification information into a graphical user interface.
The input is human-readable text or form selections, and the output is structured job profile data stored temporarily on the terminal. The terminal converts the user's selections into a key-value data structure (for example, a JSON object with fields for job category, job type, and role) and prepares the data for transmission.

### Step 2:

The terminal transmits the job profile data and applicant identification information to the server via a network connection.
The input is the structured job profile data; the output is a network message received by the server. The terminal encapsulates the data into a request message, sets headers and security credentials, and sends the message over a secure protocol so that the server can parse and store the job profile.

### Step 3:

The user operates the terminal to upload applicant history information data, such as a resume file, or image information data representing a scanned document.
The input is a local file or captured image; the output is an upload request sent to the server containing the binary data. The terminal reads the file into memory, optionally compresses it, attaches metadata such as file type and applicant ID, and transmits the data to the server.

### Step 4:

The server receives the applicant history information data or image information data and stores it in a storage device associated with the applicant profile record.
The input is the uploaded binary data stream; the output is a stored file path or database entry. The server writes the data to persistent storage, generates a unique identifier for the file, and links this identifier to the applicant's profile record.

### Step 5:

The server executes character recognition processing on the image information data when the resume is provided as an image.
The input is the stored image file; the output is raw text information extracted from the image. The server calls an optical character recognition engine with the image as input, receives recognized character sequences, and concatenates the recognized characters into paragraphs of text representing the resume content.

### Step 6:

The server executes natural language processing on the applicant history information data to extract work information, skill information, and experience information.
The input is the resume text; the output is a set of structured fields such as job titles, technologies, and durations. The server tokenizes the text, tags parts of speech, performs dependency parsing, and applies entity recognition to identify job roles, dates, and skills. The server then maps detected entities into normalized fields and stores them in the applicant profile record.

### Step 7:

The server constructs a prompt sentence for the generative AI model based on the job category information, job type information, role information, and extracted applicant information.
The input is the job profile record and the applicant profile record; the output is a natural-language prompt sentence. The server inserts field values into a template and produces a sentence such as: “Generate eight technical and four behavioral interview questions for a backend engineer in the finance sector. The candidate has 5 years of Java and microservices experience and has led 2 projects. Focus on depth of Java knowledge and leadership.”

### Step 8:

The server tokenizes the prompt sentence and invokes the generative AI model to generate interview question information.
The input is the prompt sentence; the output is generated text containing interview questions. The server converts the sentence into a sequence of token identifiers, feeds the sequence into the generative AI model, performs forward propagation through the model layers, and decodes the resulting token probabilities into a text string with multiple questions.

### Step 9:

The server post-processes the generated text to create a question set object.
The input is the generated question text; the output is a structured set of interview question information items. The server splits the text at sentence boundaries or numbering markers, trims whitespace, classifies questions as technical or behavioral based on keyword rules, assigns unique identifiers, and stores the questions as an array within a question set linked to the applicant and job profile.

### Step 10:

The server transmits the question set object to the terminal to prepare for the interview session.
The input is the structured question set; the output is a network response received by the terminal containing the questions. The server serializes the question set, sets response headers, and sends it, while the terminal deserializes the data and loads the questions into its local interview session state.

### Step 11:

The terminal presents the interview questions to the user and captures audio and video responses.
The input is the question set object; the output is recorded audio information and video information segments corresponding to each answer. The terminal displays each question on the screen or reads it aloud, starts recording from the microphone and camera, timestamps the start and end of each answer, and stores the media segments in local buffers.

### Step 12:

The terminal transmits the recorded audio information and video information segments to the server.
The input is buffered media data; the output is a set of media uploads or streams received by the server. The terminal compresses the audio and video as needed, labels each segment with question identifiers and timestamps, and sends the segments over the network to the server.

### Step 13:

The server executes speech recognition processing on each audio information segment to obtain text information.
The input is a stored audio segment; the output is a transcript of the applicant's answer. The server sends the audio to a speech-to-text engine, receives a sequence of recognized words with timing information, and merges them into sentences. The server then attaches the transcript to the corresponding answer record.

### Step 14:

The server executes acoustic analysis processing on each audio information segment to extract audio feature amounts.
The input is the audio segment; the output is an audio feature vector containing pitch information, volume information, and speaking rate information. The server computes the short-time Fourier transform, detects fundamental frequency, calculates energy and intensity, measures jitter and shimmer, counts phoneme or word boundaries, and aggregates these values into a fixed-length numeric vector stored in the audio feature vector matrix.

### Step 15:

The server executes image analysis processing on each video information segment to extract image feature amounts including expression information.
The input is the video segment; the output is an image feature vector for each time window. The server decodes frames, detects the applicant's face, computes facial landmarks, estimates expression probabilities such as happiness or nervousness, and aggregates these probabilities over the duration of the answer into a fixed-length vector, which the server stores in the image feature vector matrix.

### Step 16:

The server concatenates the audio feature amounts and the image feature amounts and feeds the combined feature vector into an emotion estimation module.
The input is the pair of audio and image feature vectors; the output is emotion state information and answer confidence information. The server constructs a single input vector by joining the two feature arrays, forwards it through the layers of the emotion neural network, and reads the output neurons representing probabilities of emotion classes and a numerical confidence score. The server stores these values in the emotion and confidence record.

### Step 17:

The server performs natural language processing on the answer text information and compares it with the applicant history information data.
The input is the transcript and the resume text; the output is a set of consistency indicators and extracted entities. The server identifies entities such as years of experience, project sizes, and tool names in the answer, aligns them with resume entries, and calculates an inconsistency score based on mismatched counts or absent entities. The server records which fields are consistent and which are divergent.

### Step 18:

The server constructs a content evaluation prompt sentence for the generative AI model using the answer text, resume excerpts, and the inconsistency indicators.
The input is the answer transcript, key resume passages, and numeric inconsistency scores; the output is a natural-language prompt sentence describing the evaluation task. The server inserts the answer, the resume information, and a description of detected mismatches into a template such as: “Analyze the following answer and the resume details. The resume indicates 3 years of backend experience, while the answer states 10 years. Estimate truthfulness, depth of expertise, and suitability for a backend engineer role.”

### Step 19:

The server invokes the generative AI model with the content evaluation prompt sentence and obtains a response content evaluation result.
The input is the content evaluation prompt sentence and referenced texts; the output is generated evaluation text describing truthfulness, expertise, and suitability. The server tokenizes the prompt and texts, runs them through the generative AI model, and decodes the output to produce an evaluation paragraph or bullet list.

### Step 20:

The server parses the response content evaluation result to derive structured truthfulness information and content quality scores.
The input is the generated evaluation text; the output is numeric or categorical ratings. The server applies pattern-matching rules or secondary classifiers to extract phrases indicating high, medium, or low truthfulness and proficiency, maps these into numerical values, and stores them in the evaluation record as truthfulness information and content quality measures.

### Step 21:

The server integrates the emotion state information, answer confidence information, and content quality scores into an aptitude estimation model.
The input is a feature vector combining emotion probabilities, confidence scores, and content metrics; the output is aptitude information for the applicant. The server feeds the vector into a trained evaluation model, runs the model's prediction routine, and obtains a continuous suitability score and sub-scores for different competency dimensions, which are stored in the evaluation record.

### Step 22:

The server generates candidate placement information based on aptitude information and predefined mappings between competency profiles and organizational units.
The input is the aptitude scores and a mapping table between competencies and departments; the output is one or more recommended departments or roles. The server compares aptitude dimensions with required patterns for each unit, computes similarity measures, ranks units, and selects top recommendations stored as candidate placement information.

### Step 23:

The server compiles aptitude information, truthfulness information, and candidate placement information into evaluation information and generates evaluation screen information.
The input is the evaluation record; the output is a structured screen definition describing how the information should be visualized. The server selects fields to display, assigns them to chart types and table positions, defines color codes for thresholds, and encodes the layout as data that can be interpreted by the terminal.

### Step 24:

The server transmits the evaluation screen information to the terminal so that the terminal can render a dashboard for the interview operator.
The input is the screen definition data; the output is a network response containing the dashboard configuration. The server sends the data, and the terminal parses it, draws charts and tables on the display, and binds interactive controls such as filters or drill-down buttons.

### Step 25:

The server monitors emotion state information and truthfulness information and generates alert information or supplemental question instruction information when a predetermined condition is satisfied.
The input is the time-series of emotion and truthfulness values; the output is a set of alert flags and optional generated supplemental questions. The server applies threshold checks and pattern detection (for example, sustained low confidence across multiple answers), creates an alert object when conditions are met, and optionally creates a new prompt sentence such as “Generate two short follow-up questions to clarify the candidate's claim about leading a large project, given that confidence appears low and inconsistencies exist with the resume,” invokes the generative AI model, and stores the resulting supplemental questions.

### Step 26:

The server transmits the alert information and any supplemental question instruction information to the terminal for presentation to the interview operator or monitoring operator. The input is the alert object and supplemental question list; the output is a network message that the terminal receives and visualizes. The terminal displays warning icons, textual explanations, and the suggested follow-up questions, and allows the interview operator to select questions to be posed to the user.

### Step 27:

The server updates scheduling and workflow records based on the evaluation information and system rules.
The input is the finalized evaluation record; the output is updated schedule records and workflow state records. The server checks aptitude thresholds and truthfulness levels, decides whether additional interviews or reviews are required, creates or modifies schedule entries accordingly, updates the applicant's stage in the workflow, and sends notifications to relevant terminals.

### Step 28:

The user reviews the dashboard and alert information on the terminal and decides on further actions such as scheduling additional interviews or finalizing a decision.
The input is the rendered dashboard and alerts; the output is new user commands entered through the terminal. The user inspects the visualized evaluation information, interacts with controls to examine detailed scores and timelines, and then submits decisions, which the terminal sends back to the server for logging and for triggering any subsequent automated processing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### SECOND EXEMPLARY EMBODIMENT

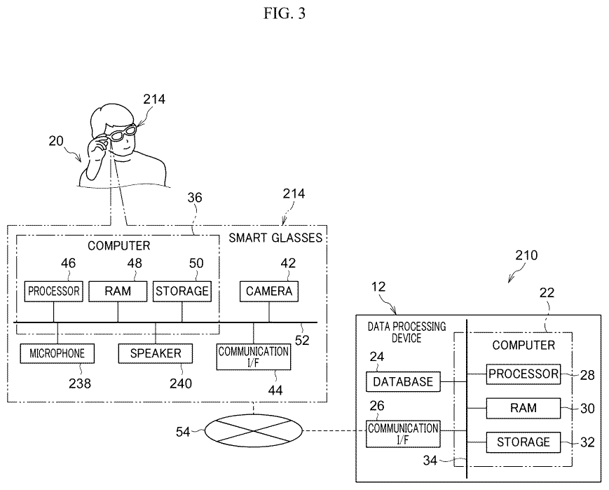

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

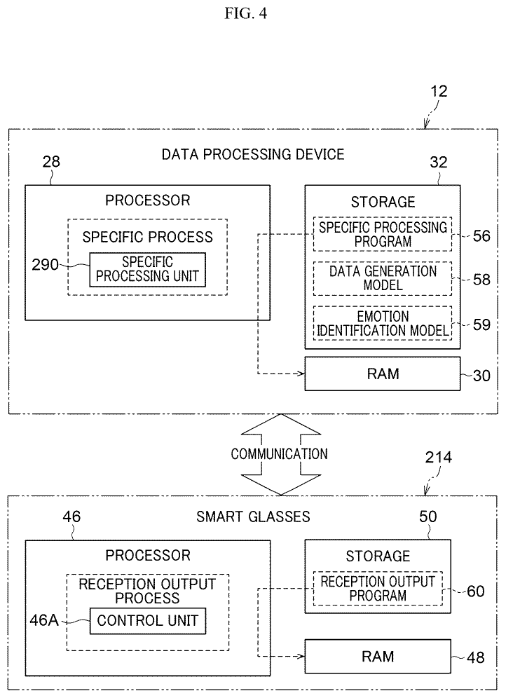

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.
The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.
Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.
Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### THIRD EXEMPLARY EMBODIMENT

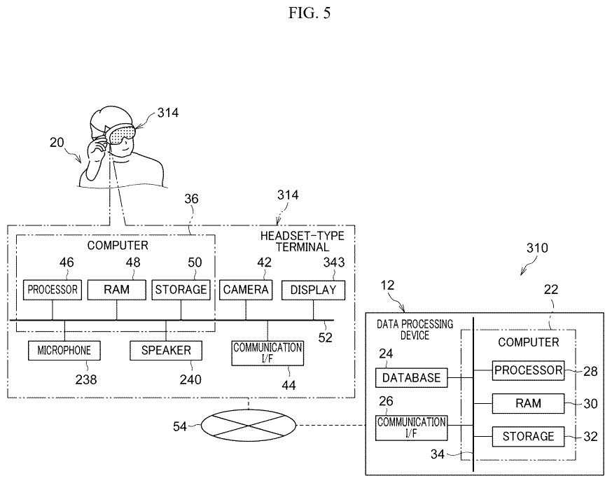

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

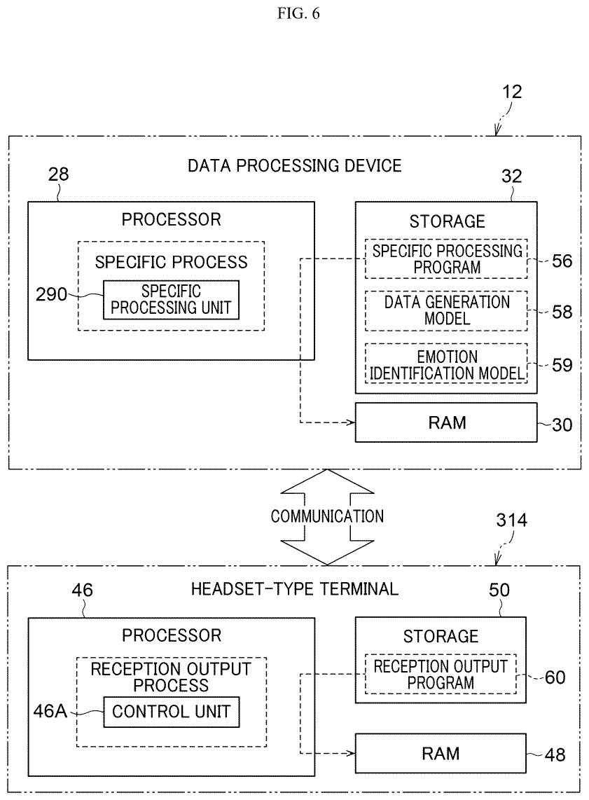

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### FOURTH EXEMPLARY EMBODIMENT

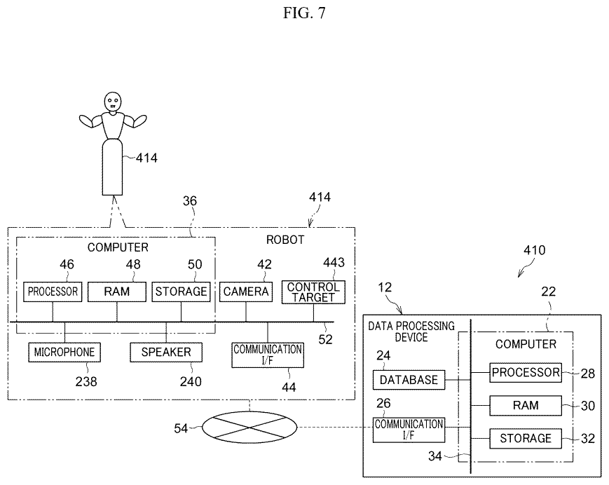

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

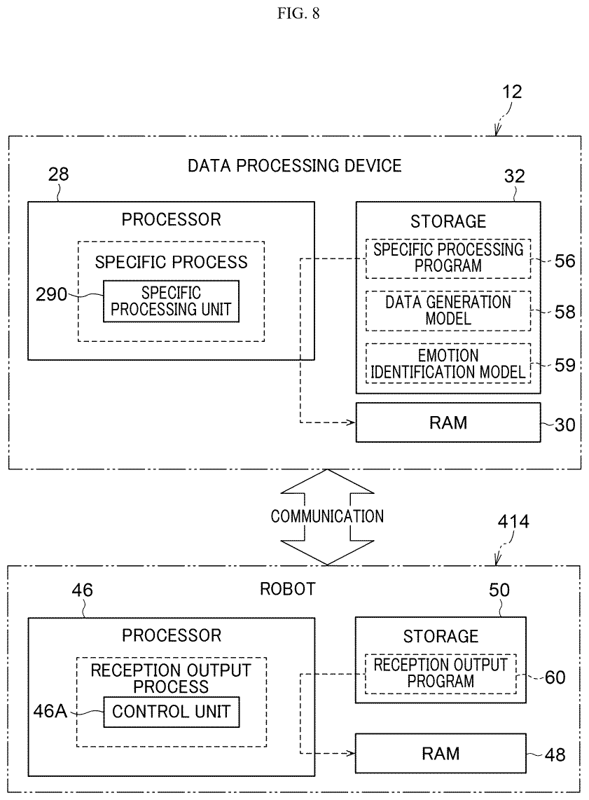

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

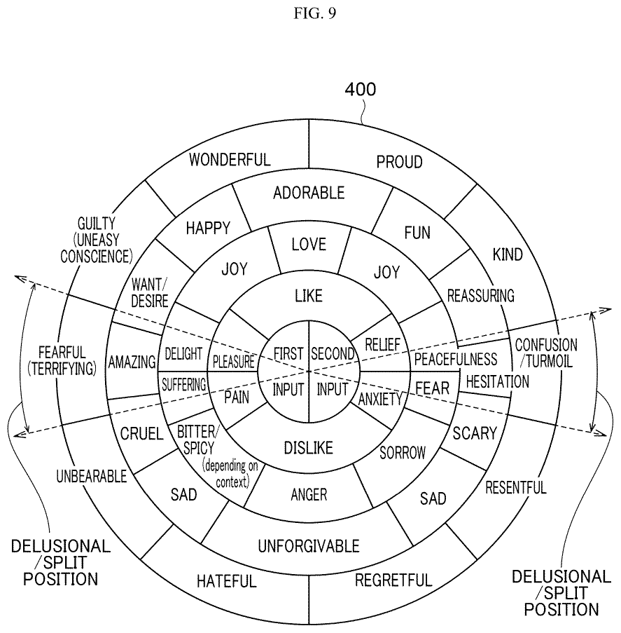

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

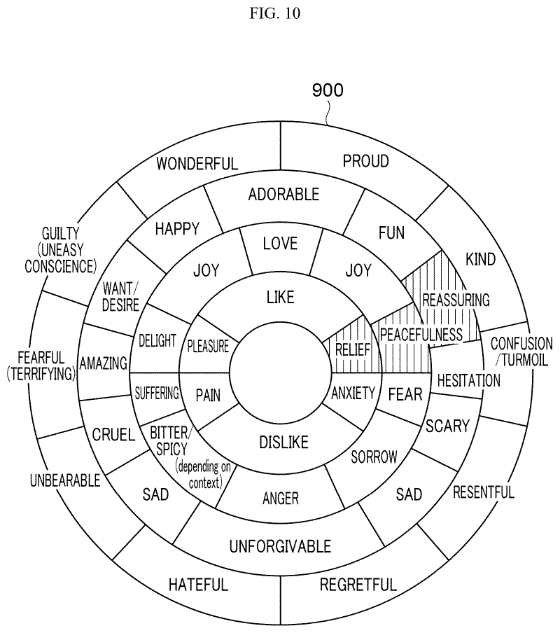

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal, attribute information including at least an industry, an occupation, a role, and history information of a candidate,
convert the history information from an electronic file into character information, apply a natural language processing algorithm to the character information to extract information including at least specialized knowledge, experience, skills, and aptitude, and generate structured information based on the extracted information,
automatically generate a prompt sentence for input to a generative AI model based on the structured information and the attribute information including at least the industry, the occupation, and the role, transmit the prompt sentence to the generative AI model, and cause the generative AI model to generate interview question text,
analyze output from the generative AI model, split the interview question text into individual questions, remove duplicate or similar questions, organize the individual questions by question category, and transmit the organized questions to the terminal, and
convert conversation audio during an interview into character information by using a speech recognition algorithm, apply an emotion analysis algorithm to at least one of the character information and acquired expression information to analyze an emotional state, and provide an analysis result of the emotional state to the terminal.

### (Supplementary 2)

The system according to supplementary 1,
wherein the processor is configured to embed, in the prompt sentence, at least a part of the industry, the occupation, the role, and the skills included in the structured information as prompt elements, and thereby instruct the generative AI model to generate interview question text specialized for the candidate.

### (Supplementary 3)

The system according to supplementary 1,
wherein the processor is configured to automatically update evaluation information and progress information related to a recruitment operation based on at least one of the interview question text and the analysis result of the emotional state, and to supply the evaluation information and the progress information to a workflow management algorithm and a scheduling algorithm so as to automate and improve efficiency of an interview process and a recruitment process.

### Application Example 1

### (Supplementary 1)

A system comprising a processor,
wherein the processor is configured to
input, into a generative AI model, a prompt sentence that instructs generation of a set of questions in accordance with a business field, a job category, and a job level, convert applicant history information into electronic information including character information by using image reading processing, and extract work experience information and skill information by using a natural language processing function, and store extracted information as structured candidate attribute information,
dynamically generate the prompt sentence to be input into the generative AI model on the basis of business field information, job category information, job level information, and skill information included in the candidate attribute information, input the prompt sentence into the generative AI model, and acquire a question set corresponding to the candidate attribute information,
transmit the acquired question set to a portable information terminal device via a communication network, and cause the portable information terminal device to display the question set so that questions can be presented in real time during an interview,
acquire conversational audio during the interview, convert the conversational audio into character information by using a speech recognition function, and analyze an emotional state from the character information and the conversational audio by using an emotion analysis function, and
acquire, on the basis of an operation input or a voice input from an interviewer, a condition relating to at least one of question difficulty, question type, and number of questions,
regenerate the prompt sentence on the basis of the condition and the candidate attribute information, and re-input the regenerated prompt sentence into the generative AI model so as to cause generation of an additional question or a modified question.

### (Supplementary 2)

The system according to supplementary 1,
wherein the processor is configured to cause a head-mounted display device to function as the portable information terminal device, and in the head-mounted display device, sequentially switch and display the acquired question set, and switch or select questions in response to an operation input from the interviewer.

### (Supplementary 3)

The system according to supplementary 1,
wherein the processor is configured to cooperate with an information processing apparatus having at least one of a schedule management function and a workflow management function, in order to assign an interviewer and to set or change an interview schedule, and to automatically execute processing procedures relating to a recruitment operation.

### Example 2

### (Supplementary 1)

A system comprising a processor,
wherein the processor is configured to
acquire condition information indicating an interview format and a target work role based on business-domain information and job information, dynamically construct a prompt sentence for causing a generative AI model to generate interview questions based on the condition information, and input the prompt sentence into the generative AI model so as to cause the generative AI model to generate a plurality of interview questions,
convert the plurality of interview questions obtained from the generative AI model into at least one output format selected from a text format, an audio format, and a video format, transmit data in the at least one output format to a terminal via a communication path, and cause the terminal to present the plurality of interview questions to an applicant,
receive response data of the applicant from the terminal as at least one of text data, audio data, and video data, execute speech recognition processing on the audio data to convert the audio data into text data, perform natural language processing on the text data to extract analysis information including emotion information and keyword information, and perform image analysis on the video data to extract expression information and emotion information, aggregate, based on the analysis information, an emotion index and a keyword index for each question and for each applicant, convert aggregation results into visualization data, construct dashboard data adapted to a display interface based on the visualization data, and transmit the dashboard data to the terminal so as to present the aggregation results to an evaluator, and convert history information of the applicant into digital data, extract related information from the history information by using natural language processing, and input, into the generative AI model, an additional prompt sentence obtained by incorporating the related information into the prompt sentence so as to cause the generative AI model to generate questions according to individual characteristics of the applicant.

### (Supplementary 2)

The system according to supplementary 1,
wherein the processor is configured to acquire available-time information of the applicant and the evaluator, use an information processing mechanism having a schedule-adjustment function to automatically determine an interview execution time and the interview format, and notify the terminal of a determination result. (Supplementary 3)
The system according to supplementary 1,
wherein the processor is configured to define processing steps including interview setting, question generation, response acquisition, analysis processing, and presentation of evaluation results as a business-process flow, and use an information processing mechanism having a workflow-management function to control the processing steps sequentially or in parallel and automatically advance interview operations.

### Application Example 2

### (Supplementary 1)

A system comprising a processor,
wherein the processor is configured to
receive job category information, job type information, and role information, and input a prompt sentence to a generative AI model so as to cause the generative AI model to generate interview question information corresponding to the job category information, the job type information, and the role information,
acquire applicant history information data or image information data, execute character recognition processing and natural language processing on the applicant history information data or the image information data to extract work information, skill information, and experience information, and input a prompt sentence including an extraction result to the generative AI model so as to cause the generative AI model to generate additional interview question information specialized for an applicant,
acquire audio information obtained during an interview, execute speech recognition processing on the audio information to convert the audio information into text information, execute acoustic analysis processing on the audio information to extract audio feature amounts including pitch information, volume information, and speaking rate information, execute image analysis processing on video information obtained during the interview to extract image feature amounts including expression information, and estimate emotion state information and answer confidence information by using the audio feature amounts and the image feature amounts,
integrate a response content evaluation result obtained by the generative AI model, the emotion state information, and the answer confidence information to calculate aptitude information, truthfulness information, and candidate placement information of the applicant, and output the aptitude information, the truthfulness information, and the candidate placement information as evaluation information,
generate evaluation screen information in which the evaluation information is visualized, and transmit the evaluation screen information to a terminal device including a display so that the evaluation screen information is presented in real time or quasi real time during or after the interview, and
determine that the emotion state information or the truthfulness information satisfies a predetermined condition, and generate alert information or supplemental question instruction information, and transmit the alert information or the supplemental question instruction information to the terminal device so that the alert information or the supplemental question instruction information is presented to an interview operator or a monitoring operator.

### (Supplementary 2)

The system according to supplementary 1,
wherein the processor is configured to use a scheduling function that manages schedule information of the interview operator and the applicant, automatically generate, update, and notify schedule information related to implementation of the interview, and thereby reduce a workload associated with arrangement of the interview operator and implementation of the interview.

### (Supplementary 3)

### The System According to Supplementary 1,

wherein the processor is configured to use a workflow management function that manages task information, progress information, and evaluation information related to a hiring workflow, automatically update a selection stage of the applicant, and control related processing steps, and thereby realize automation and efficiency improvement of hiring operations.

What is claimed is:

1. A system comprising:
circuitry configured to:
receive, via a communication interface coupled to a packet-switched network, attribute information including at least a domain category, a role category, and history information of a subject from a terminal device, convert the history information from an electronic file into character information, and apply a natural language processing algorithm to extract competency features including specialized knowledge, experience, skills, and aptitude;
generate a structured prompt sentence incorporating the extracted competency features and an instruction for a generative AI model to generate structured query data tailored to the domain category and role category, and input the prompt sentence to the generative AI model to obtain the structured query data; and
convert audio content of a dialog session into text data using a speech recognition engine, analyze an emotional state and facial expression of the subject using an emotion analysis engine, and transmit analysis results and session data to the terminal device via the communication interface.

2. The system according to claim 1, wherein the circuitry is configured to generate a first prompt sentence incorporating the domain category and the role category, and input the first prompt sentence to the generative AI model to generate a set of domain-specific structured query data.

3. The system according to claim 2, wherein the circuitry is configured to generate a second prompt sentence incorporating the extracted competency features from the history information of the subject, and input the second prompt sentence to the generative AI model to generate subject-specific structured query data.

4. The system according to claim 3, wherein the circuitry is configured to combine the domain-specific structured query data and the subject-specific structured query data into a structured query sequence, and transmit the structured query sequence to a terminal device via the communication interface.

5. The system according to claim 1, wherein the circuitry is configured to receive voice data from the terminal device during the dialog session via the communication interface, apply the speech recognition engine to convert the voice data into text data, and store the text data as dialog transcript data in a storage device.

6. The system according to claim 5, wherein the circuitry is configured to apply the emotion analysis engine to the voice data and facial expression data received from the terminal device to recognize the emotional state of the subject, and store the recognized emotional state in association with dialog transcript segments in the storage device.

7. The system according to claim 6, wherein the circuitry is configured to generate a prompt sentence incorporating the dialog transcript data and the recognized emotional state, input the prompt sentence to the generative AI model to generate a subject evaluation result, and store the evaluation result in the storage device.

8. The system according to claim 7, wherein the circuitry is configured to transmit the subject evaluation result to a designated terminal device via the communication interface, and update a subject profile stored in the storage device based on the evaluation result.

9. The system according to claim 1, wherein the circuitry is configured to use a scheduling engine to arrange dialog sessions based on availability data received from terminal devices via the communication interface, and transmit scheduling confirmations to the terminal devices.

10. The system according to claim 9, wherein the circuitry is configured to detect when a dialog session does not require human operator involvement based on a confidence score derived from the structured query data generated by the generative AI model, and release the human operator from the scheduled session.

11. The system according to claim 1, wherein the circuitry is configured to use a workflow management engine to automate at least one of subject screening, session scheduling, and evaluation report generation, and transmit workflow status updates to a management terminal device via the communication interface.

12. The system according to claim 11, wherein the circuitry is configured to detect completion of each workflow stage based on status data received via the communication interface, and automatically trigger the next workflow stage upon completion.

13. The system according to claim 1, wherein the circuitry is configured to receive, from the terminal device, a real-time transcription feed of dialog session content via the communication interface, apply natural language processing to the transcription feed, and dynamically generate follow-up query data based on the content of the dialog session.

14. The system according to claim 13, wherein the circuitry is configured to generate a prompt sentence incorporating the real-time transcription feed and an instruction for the generative AI model to generate contextually appropriate follow-up query data, and transmit the generated query data to the terminal device via the communication interface.

15. The system according to claim 1, wherein the circuitry is configured to compare evaluation results across a plurality of subjects by aggregating evaluation data stored in the storage device, and generate a prompt sentence for the generative AI model to produce a ranked comparison of subjects.

16. The system according to claim 15, wherein the circuitry is configured to incorporate the recognized emotional states of the subjects into the ranked comparison, and adjust ranking weights based on emotional consistency indicators derived from the emotion analysis engine output.

17. The system according to claim 1, wherein the circuitry is configured to store a record of structured query data, dialog transcript data, emotional state data, and evaluation results in the storage device in association with a subject identifier, and use the stored records to improve query generation for subsequent dialog sessions in the same domain category and role category.

18. A system comprising:
circuitry configured to:
receive, via a communication interface coupled to a packet-switched network, attribute information including a domain category, a role category, and history information of a subject from a terminal device, apply a natural language processing algorithm to extract competency features including specialized knowledge, experience, skills, and aptitude, and store the extracted competency features in a storage device;
generate a structured prompt sentence incorporating the extracted competency features, input the prompt sentence to a generative AI model to obtain structured query data, and receive voice data during a dialog session via the communication interface;
convert the voice data to text data using a speech recognition engine, analyze an emotional state and facial expression of the subject using an emotion analysis engine, and generate a subject evaluation result by inputting a prompt sentence incorporating the text data and the emotional state to the generative AI model; and
transmit the structured query data, the text data, and the subject evaluation result to designated terminal devices via the communication interface.

19. The system according to claim 18, wherein the circuitry is configured to use a scheduling engine to arrange dialog sessions based on availability data received via the communication interface, detect when human operator involvement is not required based on a confidence score, and use a workflow management engine to automate subject screening, session scheduling, and evaluation report generation.

20. A method comprising:
receiving, via a communication interface coupled to a packet-switched network, attribute information including at least a domain category, a role category, and history information of a subject from a terminal device, converting the history information into character information, and applying a natural language processing algorithm to extract competency features including specialized knowledge, experience, skills, and aptitude;
generating a structured prompt sentence incorporating the extracted competency features, inputting the prompt sentence to a generative AI model to obtain structured query data tailored to the domain category and role category; and
converting audio content of a dialog session into text data using a speech recognition engine, analyzing an emotional state and facial expression of the subject using an emotion analysis engine, and transmitting analysis results and session data to the terminal device via the communication interface.
